(19) United States
(12) Patent Application Publication
(10) Pub. No.: US 2025/0291423 A1
(43) Pub. Date: Sep. 18, 2025

(54) SYSTEM AND METHOD FOR GESTURE RECOGNITION

(71) Applicant: Quell Tech Limited, London (GB)

(72) Inventors: Martin TWEEDIE, London (GB); Cameron Jamie Alfred BROOKHOUSE, London (GB); Lorenzo SPREAFICO, London (GB); Albert Garcia PLAZA, London (GB); Scott Stephen Manning, Sydney (AU)

(73) Assignee: Quell Tech Limited, London (GB)

(21) Appl. No.: 19/081,591

(22) Filed: Mar. 17, 2025

(30) Foreign Application Priority Data
Mar. 15, 2024 (GB) 2403771.5

(51) Int. Cl. G06F 3/01; A63F 13/235; A63F 13/285; A63F 13/327; A63F 13/428

(52) U.S. Cl. CPC G06F 3/017; A63F 13/235; A63F 13/285; A63F 13/327; A63F 13/428; G06F 3/016

(57) ABSTRACT

A gesture recognition system for recognising gestures from input data and outputting gesture events may control a computing system. The gesture recognition system may include a plurality of devices, including one or more peripheral devices and a central device. Each peripheral device may include a set of one or more sensors for sensing one or more parameters of a set of parameters; a communication module configured to communicate with another device of the plurality of devices; and a processor. The processor is configured to process the sensor data using a rules engine and output a gesture event. The central device may include a central communication module for communicating with the one or more peripheral devices and a central processor configured, in dependence on processing one or both of (i) at least a subset of the sensor data and (ii) data relating to the gesture, to output a further gesture event.

### CROSS-REFERENCE TO RELATED APPLICATIONS

The present application claims the benefit of priority to GB Application No. 2403771.5 to Tweedie et al., filed Mar. 15, 2024, and entitled “A System and Method for Gesture Recognition”, and incorporates its disclosure herein by reference in its entirety.

### TECHNICAL FIELD

The present disclosure relates to systems and methods for gesture recognition. For example, the present disclosure relates to systems and methods for recognising gestures based on sensor data such as inertial measurement unit data.

### BACKGROUND

Wireless devices, such as wireless game controllers, can include accelerometers. Accelerometer data can be used to determine motion of the wireless device. By analysing the accelerometer data, a pattern of movement of the wireless device can be determined. This determined pattern of movement can be used to generate a control output for controlling a computer system, such as a computer game system.

Wireless systems such as wireless game systems can include a remote sensor that tracks motion of a device, for example by tracking an infrared signal emitted by the device, or by capturing movement of the device in afield of view of a camera and performing video analysis on the captured video data.

Further, devices such as fitness trackers typically have accelerometers that can be used to detect and monitor movement of a user wearing the fitness tracker. Such a device can be considered to be a wearable device. Fitness tracking devices have increased in complexity in recent years, but still remain computationally quite simple. Fitness trackers typically send data to a connected device such as a mobile telephone. Analysis of the tracking data can be carried out on the mobile telephone, or more usually in the cloud. Results of the data analysis are sent back to the mobile telephone, and perhaps back to the fitness tracker.

Such devices generally track a small number of distinct movements, in the order of one to four distinct movements. This limits the ability of the devices to distinguish between complex movements of the device. Further, such devices are typically not able to distinguish between different movements occurring at the same time.

Another approach to movement tracking is by using virtual reality (VR) systems. VR systems typically use hand-held controllers and computer vision to track a user's movements. Such systems generally include a headset with a screen and lenses to focus a stereoscopic image into the user's eyes to create a 3-dimensional image. The headset is typically paired with two wireless hand-held controllers, each having infrared or optical light sources that are tracked using cameras mounted on the headset. The controllers also contain motion tracking sensors such as accelerometers that further help with tracking the user's movements.

A drawback with relatively simplistic systems and approaches, for example as described above, is that such products are relatively easy to “trick”. A user can perform one type of movement that is registered by the device as another type of movement. This can mean that the system incorrectly determines user movement. The system can frequently miscategorise the detected motion.

A drawback with systems that rely on computer vision is the requirement for cumbersome camera set-up and careful control of room lighting to avoid motion detection errors.

A drawback with VR systems is the limitation of VR headsets, including user discomfort when wearing the headset, motion sickness and a cumbersome user experience.

It is desirable to increase the accuracy with which gestures can be detected.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to an aspect of the current subject matter, there is provided a gesture recognition system for recognising gestures from a set of input data and outputting gesture events on recognising gestures, the output gesture events being for controlling a computing system, the gesture recognition system comprising:
a plurality of devices configured to be in communication with each other; the plurality of devices comprising:
   one or more peripheral devices, each peripheral device comprising:
      a set of one or more sensors for sensing one or more parameters of a set of parameters;
      a communication module configured to communicate with another device of the plurality of devices; and
      a processor configured to:
         process sensor data generated by the set of sensors using a rules engine thereby to recognise a gesture from the sensor data; and
         output a gesture event in dependence on recognising the gesture from the sensor data; and
a central device, the central device comprising:
   a central communication module configured to communicate with the one or more peripheral devices; and
   a central processor configured, in dependence on processing one or both of (i) at least a subset of the sensor data and (ii) data relating to the gesture, to output a further gesture event;
      wherein at least one of the output gesture event and the output further gesture event is for controlling the computing system.

The rules engine may be selectable in dependence on a mode of the gesture recognition system and/or a mode of the computing system. The rules engine may include heuristic rules and a Machine Learning (ML) model. The gesture recognition system may be configured to process the sensor data using both the heuristic rules and the ML model. The gesture recognition system may be configured to process, e.g. at one or both of the processor and the central processor, the sensor data using the ML model in dependence on a result of processing the sensor data using the heuristic rules. The gesture recognition system may be configured to process one or more output of the ML model using one or more of the heuristic rules. One or more ML model may be used to process the sensor data. One or more ML model may be used to process one or more output of one or more earlier ML model. The one or more ML model and the one or more earlier ML model may be the same, though they need not be.

The set of parameters may include at least one of: an acceleration in one or more directions; one or more position data, optionally coupled with an indication of time for at least one of the one or more position data or a rate of change for at least one of the one or more position data; one or more velocity data, optionally coupled with an indication of time for at least one of the one or more velocity data or a rate of change for at least one of the one or more velocity data; a magnetic field in one or more directions; a pressure, or a pressure value; and a heart rate, or a heart rate value. The one or more position data may relate to one or more positions of at least one device of the plurality of devices. The one or more velocity data may relate to one or more velocities of at least one device of the plurality of devices.

The set of one or more sensors may include at least one of: an accelerometer; a magnetometer; a barometer; and a heart rate sensor.

The further gesture event may include a refinement of the gesture event. The further gesture event may include recognising a further gesture.

The central device may include a central memory for storing (i) the at least a subset of the sensor data, and/or (ii) the data relating to the gesture. Each peripheral device may include a memory for storing at least a subset of the sensor data.

The communication module and the central communication module may each include a respective radio configured to communicate wirelessly. Each radio may be configured to communicate using one or more of: WiFi; Bluetooth; Bluetooth Low Energy; Thread; Zigbee; and Z-Wave.

The gesture recognition system may be configured to filter the sensor data, e.g. at one or both of the processor and the central processor, before processing the sensor data. The gesture recognition system may be configured to generate, e.g. at one or both of the processor and the central processor, a haptic signal, for example by one or more of the plurality of devices, such as one or more peripheral devices. The haptic signal may be generated by a haptic actuator at one or more of the plurality of devices. The gesture recognition system may be configured to filter the sensor data, e.g. at one or both of the processor and the central processor, to reduce the effect of the haptic signal on the sensor data. The gesture recognition system may be configured, in dependence on an analysis of the sensor data, to remap the sensor data, e.g. at one or both of the processor and the central processor, before processing the sensor data. The gesture recognition system may be configured to remap the sensor data by inverting an axis along which sensor data is captured. The gesture recognition system may be configured to remap the sensor data by changing a frame of reference of the sensor data.

The central device may be configured to allocate a processing operation from a first peripheral device to a second device in the gesture recognition system, in dependence on a battery status signal of the first peripheral device and/or on a processor status signal of the first peripheral device. The central device may be configured to allocate the processing operation in dependence on determining from the battery status signal that a battery level of the first device is more than a threshold value lower than an average battery level of a group of devices comprising at least the second device. The central device may be configured to allocate the processing operation in dependence on determining from the processor status signal that a processor load of the first device is more than a threshold value higher than an average processor load of a group of devices comprising at least the second device. The group of devices may include the first device. The group of devices may include the one or more peripheral devices. The second device may include the central device.

According to another aspect of the current subject matter, there is provided a method of recognising gestures in a gesture recognition system from a set of input data and outputting gesture events on recognising gestures, the output gesture events being for controlling a computing system, the method comprising:
sensing, at one or more sensors of a set of sensors of one or more peripheral devices, one or more parameters of a set of parameters;
processing, at a first processor, sensor data generated by the set of one or more sensors using a rules engine thereby to recognise a gesture from the sensor data;
generating a gesture event in dependence on recognising the gesture from the sensor data;
processing at a second processor, one or both of (i) at least a subset of the sensor data and (ii) data relating to the gesture, and generating a further gesture event in dependence on that processing; and
outputting one or both of the gesture event and the further gesture event for controlling the computing system.

The method may include selecting the rules engine in dependence on a mode of the gesture recognition system and/or a mode of the computing system. The rules engine may include heuristic rules and an ML model. The method may include processing, e.g. at one or both of the processor and the central processor, the sensor data using the ML model in dependence on a result of processing the sensor data using the heuristic rules.

Generating the further gesture event may include refining the gesture event. Generating the further gesture event may include recognising a further gesture.

The method may include storing, at a memory of a device of the gesture recognition system, (i) the at least a subset of the sensor data, and/or (ii) the data relating to the gesture. The method may include storing, at a memory of the one or more peripheral devices, at least a subset of the sensor data.

The method may include filtering the sensor data before processing the sensor data.

A haptic signal may be generated by one or more of the plurality of devices, for example one or more peripheral devices. The haptic signal may be generated by a haptic actuator at one or more of the plurality of devices. The method may include filtering the sensor data to reduce the effect of the haptic signal on the sensor data.

The method may include, in dependence on an analysis of the sensor data, remapping the sensor data, e.g. at one or both of the processor and the central processor, before processing the sensor data. The method may include remapping the sensor data by inverting an axis along which sensor data is captured.

The method may include allocating a processing operation from a first peripheral device to a second device in the gesture recognition system, in dependence on a battery status signal of the first peripheral device and/or on a processor status signal of the first peripheral device. The method may include allocating the processing operation in dependence on determining from the battery status signal that a battery level of the first device is more than a threshold value lower than an average battery level of a group of devices comprising at least the second device. The method may include allocating the processing operation in dependence on determining from the processor status signal that a processor load of the first device is more than a threshold value higher than an average processor load of a group of devices comprising at least the second device.

According to another aspect of the current subject matter, there is provided a gesture recognition system configured to perform a method as described herein.

According to another aspect of the current subject matter, there is provided computer readable code configured to cause a method as described herein to be performed when the code is run.

According to another aspect of the current subject matter, there is provided a gesture recognition system as described herein wherein the gesture recognition system is embodied in hardware on an integrated circuit.

According to another aspect of the current subject matter, there is provided a computer readable storage medium having encoded thereon computer readable code configured to cause the method as described herein to be performed when the code is run.

According to another aspect of the current subject matter, there is provided computer program code for performing any of the methods described herein. There may be provided a non-transitory computer readable storage medium having stored thereon computer readable instructions that, when executed at a computer system, cause the computer system to perform any of the methods described herein.

The above features may be combined as appropriate, as would be apparent to a skilled person, and may be combined with any of the aspects of the examples described herein. Such combinations have not been written out in full for the sake of brevity.

### BRIEF DESCRIPTION OF THE DRAWINGS

Examples will now be described in detail with reference to the accompanying drawings in which:

FIGS. 1A and 1B show a pair of hand controllers of a gesture recognition system;

FIG. 2 shows a chest unit of the gesture recognition system;

FIG. 3 shows a charging dock of the gesture recognition system;

FIG. 4 shows a central device of the gesture recognition system;

FIG. 5 shows a schematic illustration of a peripheral device of the gesture recognition system;

FIG. 6 shows a schematic illustration of another peripheral device of the gesture recognition system;

FIG. 7 shows a schematic illustration of a central device of the gesture recognition system;

FIGS. 8A and 8B show two wrist straps for use with the gesture recognition system;

FIGS. 9A and 9B show two resistance bands for use with the gesture recognition system;

FIGS. 10A and 10B show other views of the pair of hand controllers;

FIGS. 11A and 11B show lower and upper perspective views of the chest unit;

FIGS. 12A and 12B show lower and upper perspective views of the charging dock;

FIG. 13 shows the pair of hand controllers and the chest unit located in the charging dock;

FIG. 14 shows the attachment of an end of a resistance band to the belt;

FIG. 15 shows the chest unit partially inserted in a pocket in the belt;

FIG. 16 shows the resistance bands attached to the belt, as the belt is being put on by a user;

FIG. 17 shows the location of the chest unit in the belt when the belt is worn by a user;

FIG. 18 shows the attachment of an end of a resistance band to a wrist strap when being worn by a user;

FIG. 19 shows a user holding two hand controllers;

FIG. 20 shows a user performing a gesture;

FIG. 21 shows an inference overview process;

FIG. 22 shows a hand controller inference pipeline;

FIG. 23 shows a chest unit inference pipeline;

FIG. 24 shows an inference process for determining a BLOCK transition;

FIG. 25 shows a CALORIE inference process;

FIG. 26 shows a process to check whether the system is in the high energy mode;

FIG. 27 shows an inference process in the high energy mode;

FIG. 28 shows an inference process in a low energy mode;

FIG. 29 shows pre-inference rejection rules;

FIG. 30 shows a combat hand inference process;

FIG. 31 shows a process for determining a gesture strength;

FIG. 32 shows a process for determining an orientation of the chest unit; and

FIG. 33 shows a process to check for a situation in which the chest unit is flat.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The current subject matter is not limited to the embodiments described herein and various modifications to the disclosed embodiments will be apparent to those skilled in the art.

Embodiments will now be described by way of example only.

The present techniques aim to provide a gesture recognition system with an improvement in accuracy of gesture detection. The present techniques aim to provide a gesture recognition system with an increase in the number of distinct gestures that can reliably be detected. The present techniques aim to provide a gesture recognition system with a reduction in gesture recognition latency.

In at least some implementations, some or more of these aims are addressed by providing a distributed system of devices, in which data analysis can be carried out at more than one of the devices. That is, at least some implementations include a network of devices where data is shared over the network. Data processing can occur at a device on the network that is suited to performing that data processing. Data can be processed at a device that captures the data. Alternatively, data can be processed at a device remote from the device that captured that data. Data from more than one device can be processed at a single device, enabling multiple data sets to be included in the data processing. Analysis of data from multiple sources can be used to improve the accuracy and/or latency of gesture recognition compared to analysing those multiple sources separately.

The present techniques can make use of artificial intelligence (AI) such as Edge AI in the processing of data captured by the devices of the gesture recognition system. The AI used is selected to be able to run on a device of the system, rather than on a client system, as is typical. The client system might be one that is configured to perform processing locally, for example at a hard drive of a desktop PC. The client system might be one that is configured to perform processing remotely, for example on a cloud computing platform. The client system might be one that is configured to perform processing both locally and remotely. An example of a client system is one where sensor data is transmitted to a connected computer, such as a PC or console, and the sensor data is processed at the connected computer. The use of AI on a device of the gesture recognition system, which has more limited power and processing capability than is available in a cloud computing platform, may at first sight appear to give a worse result—either in accuracy or timing. However, the present inventors have realised that a version of AI suitable for use on lower powered devices can actually improve results, for example when combined with the processing strategies described in more detail herein.

Edge AI is an example of an ML model that is deployable on a wireless device and can be used to process data captured by that device, e.g. by sensors of that device. Tiny ML is a subcategory of Edge AI where machine learning algorithms can be run on embedded devices. Such applications of ML models typically require an advanced processing technique to achieve good performance on the significantly lower available memory, storage capacity, and processing power offered by microcontrollers (compared to larger computing devices, or cloud-linked computing devices).

The present inventors have realised a way to implement an ML model, e.g. Tiny ML, in one or more devices of the gesture recognition system described herein, to enable real time gesture classification with high accuracy (typically >95% accuracy) and low latency (typically <150 ms latency at least and suitably <100 ms).

In the present disclosure, the techniques will be described in the context of a gesture recognition system for obtaining input for a computer gaming system, but it will be appreciated that the disclosure is not limited to such systems. For example, the techniques described herein are more widely applicable to gesture-based control of computing systems more generally.

The present techniques are useful to create a new type of immersive gaming experience. The gaming experience can relate to a fitness game, with varying levels of intensity. The intensity levels can be user-selected, and/or can be tailored to a user based on how the user interacts with the system, or uses the system. The gaming experience can offer high-intensity, full-body, resistance-based combat experiences.

The use of an ML model such as Edge AI can enable the embedding of machine learning into a device such as a hand controller of the gesture recognition system, rather than requiring the ML model to be on a host computer. The embedding of the ML model in the devices of the present system enables rapid, high-accuracy motion tracking. The embedding of the ML model in the devices of the present system means that motion tracking performance is not dependent on performance of a host computer, and so performance will not suffer when the host computer is a low-end computer. The embedding of the ML model in the devices of the present system means that motion tracking performance is not dependent on internet connection speed or stability, and so a more consistent performance can be achieved. The embedding of the ML model in the devices of the present system means that motion tracking performance is not dependent on an environment in which the device is used, and so a more consistent performance can be achieved, for example irrespective of whether a room is light or dark, or whether a line of sight can be maintained between different parts of a multi-part system (e.g. a light-emitting part and a light-receiving part). The embedding of the ML model in the devices of the present system helps reduce or minimise the need for platform-specific optimisations, which might otherwise be needed to ensure adequate performance on different host computers or host computer platforms. Thus, the present techniques help reduce development cost, since the processing does not need to be different on different host systems.

Conventional motion tracking systems generally need to stream sensor data to a client device for processing of that sensor data, thereby risking lower performance due to data loss and/or high battery consumption. The present techniques reduce or avoid the need for such data streaming to a client device, hence helping to improve performance and/or battery life.

Further, the present techniques can help provide a gesture recognition system that is easier to pick up and use, and/or is insensitive to ambient lighting conditions, player position and/or occlusion of the controllers from view, compared to VR systems and other computer vision motion tracking systems.

Use of the present techniques, helping to achieve a low level of latency (e.g. less than about 150 ms, and suitably less than about 100 ms) will be beneficial to a wide range of applications, for example in fitness gaming, human-computer interaction, sports science and biomechanical research.

To obtain the benefits of the present techniques, the inventors built a large set of exercise motion data, using proprietary hardware to capture data from identified key parts of the body. This enabled identification of a wide range of movement. The present inventors identified optimal locations of sensors on the body, the configuration and type of those sensors, and the preparation of the resulting data to be used in training a machine learning (ML) model.

The exercise data was studied and manipulated using a range of preprocessing techniques to remove spurious actions and to augment it by engineering features with greater predictive power. The resulting exercise data was used to train a neural network, helping enable the mapping of real-world motions into the computer environment (e.g. a game world) faster and more accurately than was previously achievable.

Optimal model architectures were produced which were more suited than typical models for deployment to the resource-constrained environment of a microcontroller.

Technology was developed to capture and label training data from live human-computer interactions (e.g. gameplay sessions using the devices of the present system) and using these data to produce higher-performing heuristics and models for the classification of user movements than was possible with data recorded in constrained, static environments. The present inventors have found that data recording which relies on isolated gestures recorded from a fixed pose, outside a movement context (such as a game context), were less accurate than data recording which relies on gestures occurring within a movement context. That is, recording data relating to a movement that occurs at the same time as at least some other movement, and using such data to train an ML model, is likely to result in the trained ML model predicting movements or gestures in response to input data in a way that gives higher accuracy results, compared to an ML model that is trained on isolated movements.

The present techniques aim to implement advantageous aspects in a gesture recognition system that includes three devices (which may each be termed a ‘controller’). One controller can be held in each hand, and a third controller can be mounted in a belt worn around a user's waist. In some implementations, a greater number of devices can be provided, for example, for data redundancy or to obtain additional information. Additional devices can be used to track additional movements. For example, a leg device can be used to track movements of a leg. In other implementations, fewer devices can be provided. For example, in some implementations it may not be necessary to provide two hand controllers.

Each device (or controller) suitably contains inertial sensors and a microcontroller. Data from these sensors are fed through a rules engine (which can be called an ‘inference engine’; a process of ‘inference’ can include applying a rules engine to data, ‘inferring’ likely output results, e.g. predicting an output result based on the input data) which classifies user actions in real-time. The rules engine can also supplement captured data with additional data such as a measure of the strength with which the user performs the movements. The rules engine can also be used to identify where an output of the ML model is suspected to belong to a class outside a target class. An input will always generate an output of some kind from a conventional neural network, but this output may not be a ‘correct’ output. For example, a flick of the wrist may be misclassified as a straight punch. With the present techniques, a wrist flick can be distinguished from a straight punch, and feedback to a user can help improve user technique when using the controllers. Where an output of the ML model is suspected to belong to a class outside a target class, the rules engine can decide that no gesture is output. The ML model can decide that the output is not close enough to one of a plurality of accepted outputs, and that the possible gesture should be rejected. Heuristics and/or one or more additional ML models can be applied to one or more outputs of the ML model, optionally in conjunction with the input data, to determine that the original one or more outputs is/are not close enough to one or more of a plurality of acceptable outputs, and that the possible gesture should be rejected. The rules engine suitably processes input data, and/or data at an intermediate layer of the ML model, such as before an output, and assesses whether such data is sufficient for an output of the ML model to be trusted (considered accurate). Where the output would not be considered accurate, processing of that data can be stopped, saving processing power and time.

An implementation of a gesture recognition system will now be described in more detail with reference to the drawings. A gesture recognition system can include peripheral controllers and a central controller. In the example illustrated in FIG. 1, the peripheral controllers include two hand controllers 102, 104. Each hand controller includes a respective body 106, 108. Each hand controller includes inputs for receiving user input commands. These inputs can take any suitable form. As illustrated, the inputs include a thumbstick controller 110, 112 and one or more buttons 114, 116.

The hand controllers typically have inputs comprising three buttons, a bumper/trigger, and an analogue stick with centre push. These inputs are used to control various functions of a computer system, e.g. in-game functions like menu navigation, player movement, camera angle, and in-game ability or spell selection. The inputs are laid out in such a way that they are easy to reach using the thumb for the widest possible range of hand sizes and present a natural location to rest the thumb when not in use, e.g. during combat actions. The components are designed to be hard-wearing to stand up to rough handling during use. The hand controller can include an LED for indicating controller status, such as whether it is on or off, and whether a hand unit is waiting to be paired with another device of the gesture recognition system.

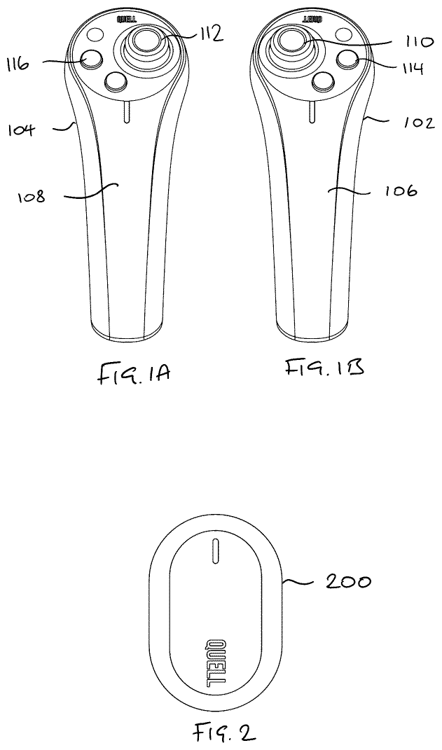

FIG. 2 shows an example of another peripheral device of the gesture recognition system. FIG. 2 illustrates a chest unit 200, suitable for mounting near to or against a user's chest, in a manner that will be described elsewhere herein.

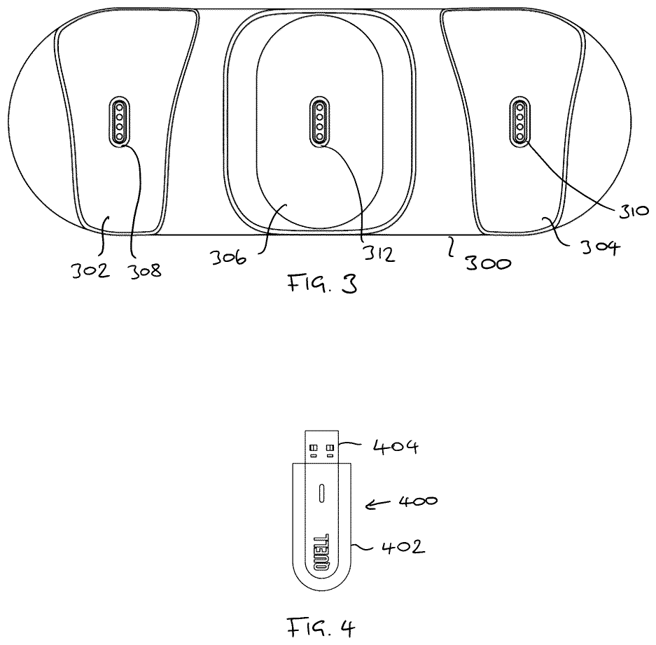

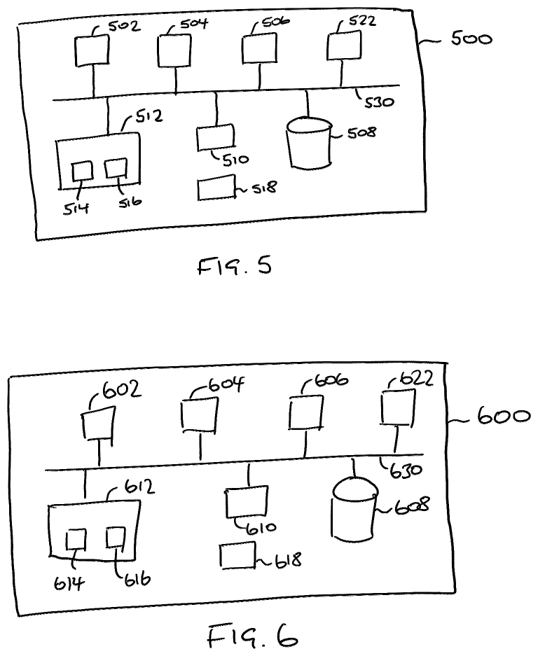

Devices of the gesture recognition system are suitably powered by rechargeable batteries. The devices are chargeable via a separate charging dock 300, as illustrated in FIG. 3. The charging dock 300 includes hand controller recesses 302, 304 for receiving the two hand controllers illustrated in FIG. 1. The charging dock 300 includes a chest unit recess 306 for receiving the chest unit illustrated in FIG. 2. Each of the recesses 302, 304, 306 of the charging dock 300 include a charging coupler 308, 310, 312. As illustrated, the charging couplers each include a set of pogo pins. Magnets can also be provided to help ensure good contact, and reliable charging, when a device is located on the charging dock. The charging dock 300 includes a port such as a USB-C port for coupling the charging dock to a power source.

In some implementations, the charging dock can include the central controller. In such implementations, the charging dock is directly couplable to the client device, for example over a USB connection.

Each device can measure the status of its own battery, for example by using the output voltage of the battery. Battery status, e.g. percentage battery remaining, and/or an estimate of time remaining, can be sent to another part of the gesture recognition system. For example, this information can be sent to a client device to inform a user and guide the user to recharge the device(s) when needed.

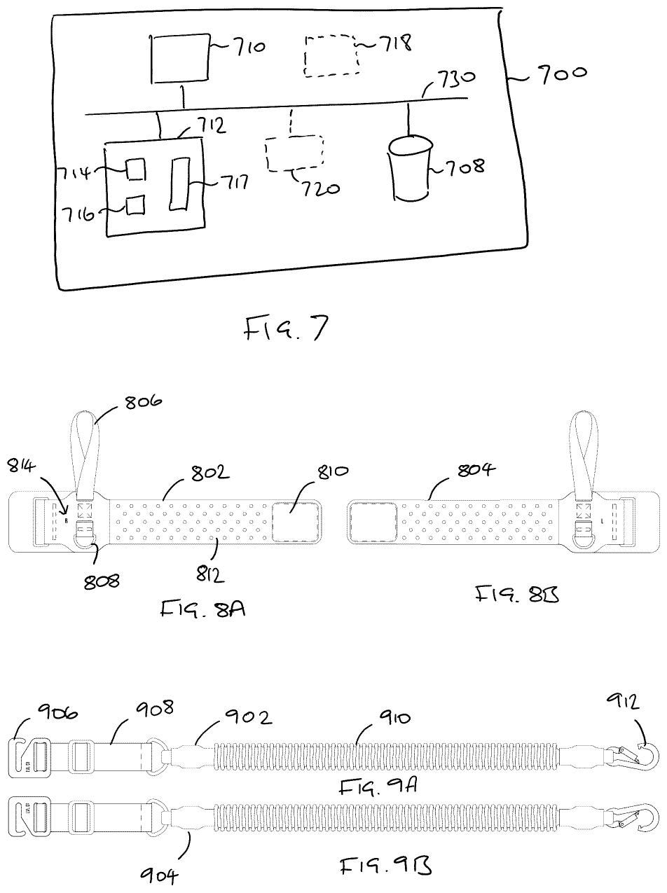

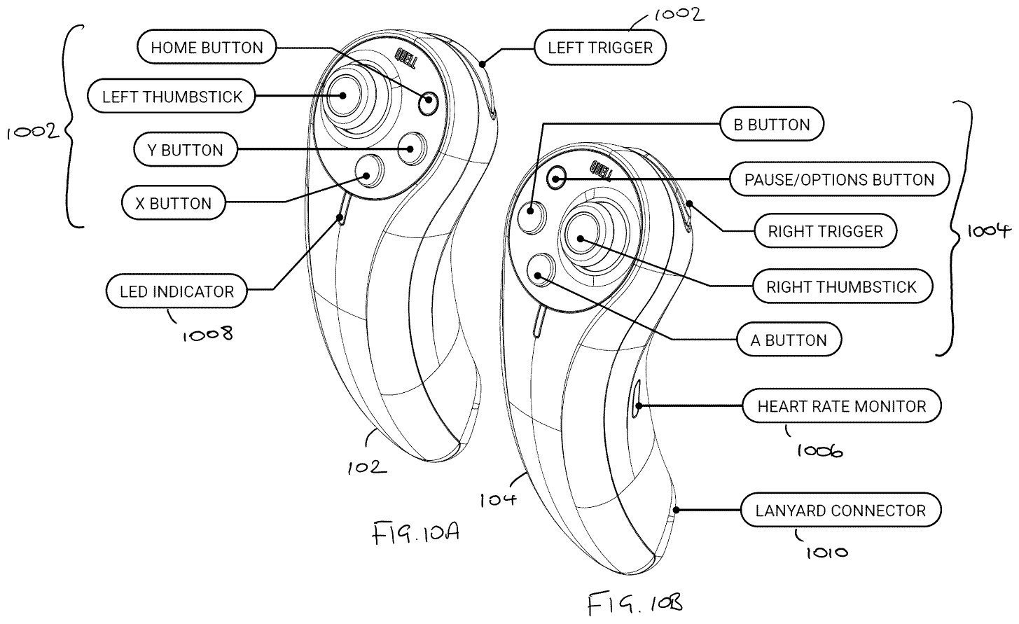

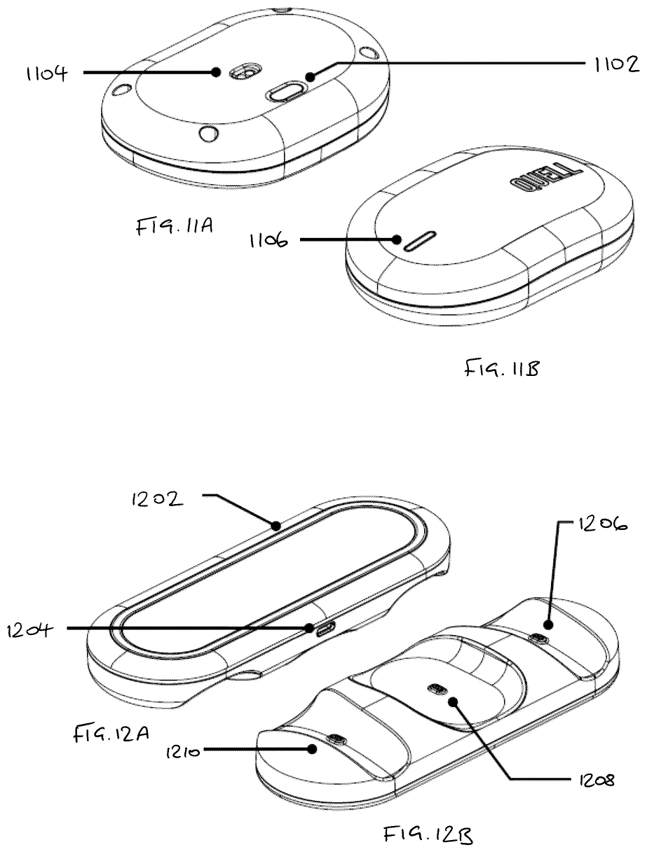

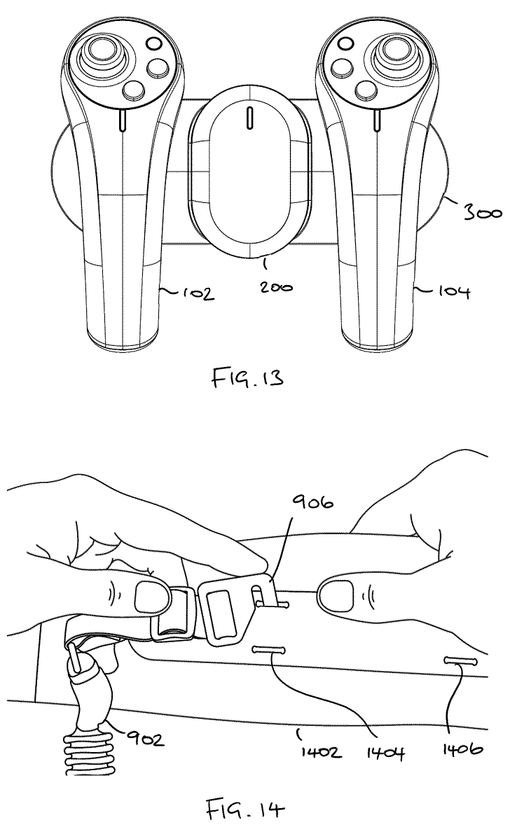

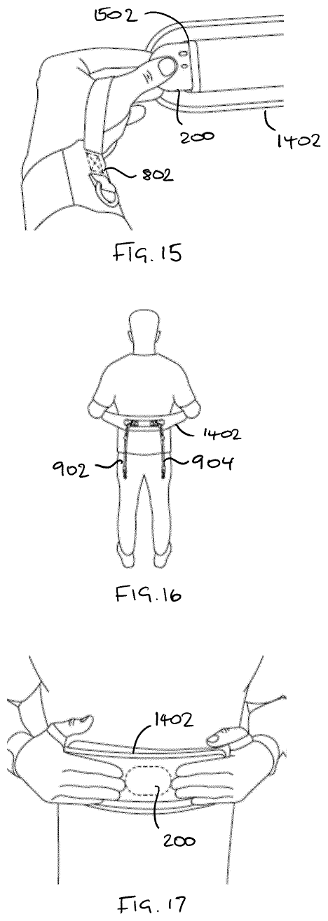

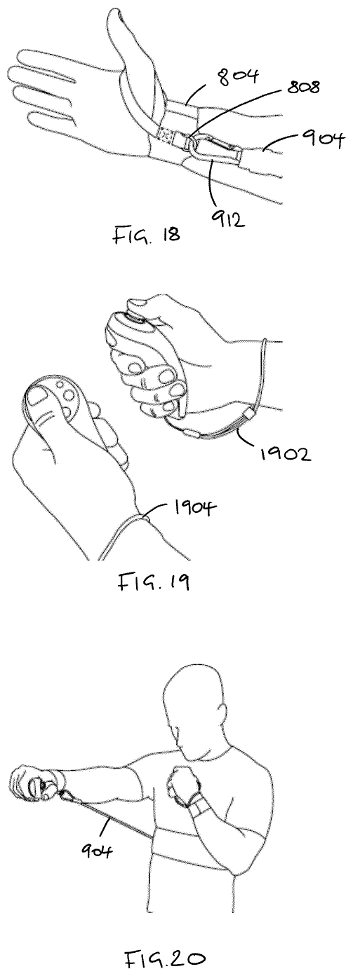

The gesture recognition system includes a central controller 400 (see FIG. 4). The central controller is, in this example, in the form of a dongle, such as a USB dongle, comprising a body 402 and a USB connector 404 for coupling to a client device, such as a PC.

Each of the peripheral devices includes a set of sensors. The set of sensors includes one or more of the following types of sensor: an inertial measurement unit (IMU), e.g. a six-axis inertial measurement unit, which might include a three-axis accelerometer (for sensing linear motion) and a gyroscope (for sensing rotational motion); a three-axis magnetometer (for sensing magnetic field strength); a barometer (for sensing pressure/altitude); and a heart rate monitor. Suitably, the barometer is provided in the chest unit. There is no need to provide a barometer in another device, but there may be a barometer provided in one or more other device. Suitably, the heart rate monitor is provided in one of the hand controllers. There is no need to provide a heart rate monitor in another device, but there may be a heart rate monitor provided in one or more other device.

Suitably, the three-axis accelerometer is configured to determine an acceleration in an x-direction (a_x), an acceleration in a y-direction (a_y) and an acceleration in a z-direction (a_z). The x-direction is along an x-axis in a Cartesian coordinate system; the y-direction is along a y-axis in a Cartesian coordinate system; the z-direction is along a z-axis in a Cartesian coordinate system. The Cartesian coordinate system can be oriented as desired, but it is convenient to arrange the coordinate system so that the y-axis is generally vertical, and the x- and z-axes define a generally horizontal plane.

Each device is configured to perform at least some data processing on data generated by the set of sensors at that device. The central controller is configured to perform at least some data processing on data generated by a set of sensors at at least one other device. The central controller may be configured to perform at least some data processing on data generated by a set of sensors at at least one other device together with data generated by a set of sensors at the central controller. Further data processing may occur at a client device, such as a desktop PC, tablet, or mobile phone.

The central controller is suitably configured to output a clock signal. Where the central controller generates sensor data, this sensor data is synchronised with the clock signal. The other devices are configured to synchronise data generated by the respective sets of sensors with the clock signal. The central controller may include a clock configured to generate the clock signal. The central controller may output the clock signal in dependence on a clock at the client device, to which the central controller is coupled. Where the central controller includes a clock, the central controller is suitably configured to synchronise this clock with the clock at the client device. Data generated by the devices may therefore include or be associated with the clock signal, and/or synchronisation data.

Referring to FIG. 5, an example hand controller 500 includes a six-axis accelerometer 502, a magnetometer 504 and a heart rate sensor 506. In other example hand controllers the heart rate sensor 506 need not be provided. Suitably, for a pair of hand controllers, one of the hand controllers (e.g. a right hand controller) is provided with the heart rate sensor. The heart rate sensor may include a photoplethysmographic sensor.

The heart rate sensor is suitably located on the hand controller to be adjacent a user's palm when the hand controller is being held by a user. This location was found to permit the collection of data from a majority of users while reducing the dependence of signal quality on skin pigmentation, thus increasing overall accuracy. However, difficulties arise where uses of the devices require or encourage a user to perform frequent vigorous movements with their hands, because such uses can result in large fluctuations in signal intensity and perfusion index when the grip pressure changes, and/or smaller fluctuations resulting from the movement itself. The present inventors have identified that it is possible to use sensor fusion to correct for fluctuations during periods of low user movement. These periods can be identified by monitoring the IMU data, enabling systems to control when heart rate should be measured, correct for fluctuations during this time, and report heart rate to the client device.

The hand controller further includes a data store 508 such as a memory, for example flash memory. The memory suitably includes a RAM. Each of the sensors is coupled to the data store for storing data generated by the sensors in the data store. The data store may include a buffer, such as a first in, first out (FIFO) buffer. Thus, the data store can store data generated over a number of time periods (also called ‘frames’).

The hand controller further includes a processor 510. The processor is able to access data generated by each of the sensors. The processor may be coupled to one or more of the sensors to receive the data from the sensors. Coupling the processor directly to the sensors can help provide the sensor data to the processer with minimum time delay. The processor may be coupled to the data store for accessing data stored at the data store. Coupling the processor to the data store helps ensure that the processor has access to the sensor data, even if the processor is unable to sample that data ‘live’, as it is generated by the sensor(s). Coupling the processor to the data store helps ensure that the processor has access to data relating to one or more previous frames. The number of previous frames for which the data is stored and is therefore accessible to the processor, will depend on the size of the data store. The size of the data store selected is likely to be a balance between having data available for a greater number of previous frames (increasing the size of the data store, and its cost) and reducing the footprint of the data store and its cost.

The hand controller includes a communication module 512. The communication module is configured for communicating with one or more other device of the system, for example a central controller. Suitably, the communication module is configured to communicate wirelessly, for example using one or more of the following communication protocols: WiFi, Bluetooth, Bluetooth Low Energy (BLE), Thread, Zigbee, and Z-Wave. Suitably, the communication protocol used by the communication module includes BLE. The communication module 512 includes a radio configured to communicate using the one or more communication protocols. The radio illustrated in FIG. 5 includes a transmitter 514 and a receiver 516. In other examples, a transceiver may be provided. In some examples, the hand controller need not be configured to receive data, and so the receiver 516 need not be provided.

The hand controller further includes a battery 518, so that the hand controller can be used wirelessly. The battery is suitably rechargeable.

One or more of the components of the hand controller are coupled to one or more of the other components of the hand controller over a communication link 530, which may include a communication bus.

Referring to FIG. 6, an example chest unit 600 includes a six-axis accelerometer 602, a magnetometer 604 and a barometer 606. The chest unit further includes a data store 608 such as a memory, for example flash memory. The memory suitably includes a RAM. Each of the sensors is coupled to the data store for storing data generated by the sensors in the data store. The data store may include a buffer, such as a first in, first out (FIFO) buffer. Thus, the data store can store data generated over a number of time periods (also called ‘frames’).

The chest unit further includes a processor 610. The processor is able to access data generated by each of the sensors. The processor may be coupled to one or more of the sensors to receive the data from the sensors. Coupling the processor directly to the sensors can help provide the sensor data to the processer with minimum time delay. The processor may be coupled to the data store for accessing data stored at the data store. Coupling the processor to the data store helps ensure that the processor has access to the sensor data, even if the processor is unable to sample that data ‘live’, as it is generated by the sensor(s). Coupling the processor to the data store helps ensure that the processor has access to data relating to one or more previous frames. The number of previous frames for which the data is stored and is therefore accessible to the processor, will depend on the size of the data store. The size of the data store selected is likely to be a balance between having data available for a greater number of previous frames (increasing the size of the data store, and its cost) and reducing the footprint of the data store and its cost.

The chest unit includes a communication module 612. The communication module is configured for communicating with one or more other device of the system, for example a central controller. Suitably, the communication module is configured to communicate wirelessly, for example using one or more of the following communication protocols: WiFi, Bluetooth, Bluetooth Low Energy (BLE), Thread, Zigbee, and Z-Wave. Suitably, the communication protocol used by the communication module includes BLE. The communication module 612 includes a radio configured to communicate using the one or more communication protocols. The radio illustrated in FIG. 6 includes a transmitter 614 and a receiver 616. In other examples, a transceiver may be provided. In some examples, the chest unit need not be configured to receive data, and so the receiver 616 need not be provided.

The chest unit further includes a battery 618, so that the chest unit can be used wirelessly. The battery is suitably rechargeable.

One or more of the components of the chest unit are coupled to one or more of the other components of the chest unit over a communication link 630, which may include a communication bus.

Sensor data from the IMUs (e.g. acceleration and gyroscopic motion) can be used to interpret a user's movements. Other sensor data can be passed to the classification pipeline to enhance classification accuracy. For example, magnetometer data can be used to enhance the calculation of yaw in dead-reckoning techniques to determine, for example, absolute orientation, velocity, and/or position. Barometer data can be used to determine the relative z-direction change of the chest unit.

The heart rate monitor can be used to determine the user's true exertion level. This will not directly contribute to gesture inference but is intended as an additional input to the computing system to allow game intensity to be dynamically adjusted up or down according to the user's physical performance.

The location of the heart rate sensor on a hand controller introduces difficulties in continuously extracting accurate heart rate data due to disturbances of the contact between a user's hand and the heart rate sensor caused by movement and/or pressure changes. To overcome such issues, in the present techniques, inertial data is combined with the heart rate data to provide a confidence score with the heart rate value. Heart rate values from periods where the disturbance is too great to reliably determine the user's heart rate can be discarded.

A calorie burn value of the user can be determined, based on inertial data and heart rate. The calorie burn determination can be made at a device of the system, such as the central controller and/or on the client device. Suitably the final calculation is made on the client device.

Referring to FIG. 7, an example central controller 700 (such as a dongle) includes a data store 708 such as a memory, for example flash memory. The memory suitably includes a RAM. The data store may include a buffer, such as a first in, first out (FIFO) buffer. Thus, the data store can store data generated over a number of time periods (also called ‘frames’).

A frame, or IMU frame, suitably represents a snapshot of IMU data over a given time period. The system is configured to sample an IMU at a given frequency. This frequency sets the given time period. For example, where sampling occurs at a frequency of 100 Hz, the given time period will be 10 ms. Where sampling occurs at a frequency of 200 Hz, the given time period will be 5 ms. Where sampling occurs at a frequency of 400 Hz, the given time period will be 2.5 ms. Where sampling occurs at a frequency of 600 Hz, the given time period will be approximately 1.67 ms. Where sampling occurs at a frequency of 1000 Hz, the given time period will be 1 ms. The sampling rate is suitably set to achieve a balance between a rate low enough to avoid acquiring too much data (meaning that processing power and time will increase) and a rate high enough that the system is not too slow to respond to actions (e.g. where an action starts in the time between successive samples), or inaccurate due to not obtaining sufficient data points in a given time period, thereby potentially introducing sampling errors. Suitably, therefore, the sampling rate is at least 100 Hz, or at least 200 Hz, or at least 400 Hz. Suitably, the sampling rate is up to 1000 Hz, or up to 600 Hz, or up to 400 Hz.

The central controller further includes a processor 710. The processor is able to access data at the data store. The processor may be coupled to the data store for accessing data stored at the data store. Coupling the processor to the data store helps ensure that the processor has access to data relating to one or more previous frames. The number of previous frames for which the data is stored and is therefore accessible to the processor, will depend on the size of the data store. The size of the data store selected is likely to be a balance between having data available for a greater number of previous frames (increasing the size of the data store, and its cost) and reducing the footprint of the data store and its cost.

The central controller includes a communication module 712. The communication module is configured for communicating with one or more other device of the system, for example one or more peripheral devices. Suitably, the communication module is configured to communicate wirelessly, for example using one or more of the following communication protocols: WiFi, Bluetooth, Bluetooth Low Energy (BLE), Thread, Zigbee, and Z-Wave. Suitably, the communication protocol used by the communication module includes BLE. The communication module 712 includes a radio configured to communicate using the one or more communication protocols. The radio illustrated in FIG. 7 includes a transmitter 714 and a receiver 716. In other examples, a transceiver may be provided.

The central controller may include a battery 718. Where provided, the battery is suitably rechargeable. The central controller is suitably configured to couple directly to a client device, such as a host PC. The central controller may therefore be powered by the client device, and so need not include a battery. However, the provision of a battery on the central controller helps ensure stability of power to the central controller, for example in the event of a client device experiencing a power interruption, or a temporary disconnection between the central controller and the client device, which may occur if the central controller is removed from the client device for a short time.

The communication module 712 suitably includes a client device interface 717. The client device interface 717 is configured for coupling the central controller 700 to a client device. The client device interface 717 suitably includes a USB connection, such as a USB-B connector or a USB-C connector. Any other suitable connection may be provided, depending on the nature of the client device to which the central controller is to be coupled, and the technology standard.

The central controller may further include a clock 720. The clock 720 can be configured to output a clock signal. The clock may be configured to generate the clock signal. The clock is suitably configured to output a clock signal that is synchronised with a clock of the client device to which the central controller is coupled.

One or more of the components of the central controller are coupled to one or more of the other components of the central controller over a communication link 730, which may include a communication bus.

The processors 510, 610, 710 at two or more of the devices may be the same, though they need not be. Providing the same (or similar) processors at two or more of the devices means that processing can be carried out at any of those devices, without needing to factor in differing processing capabilities.

The peripheral devices can be networked together, for example using a protocol such as a 2.4 GHz protocol. Networking the devices together enables further data processing to be performed, for example using data passed from one or more of the hand controllers to the chest unit and collected together with chest unit data. The network suitably includes the central controller. Data processing, for example using data from more than one of the peripheral devices, can be performed at the central controller.

In some examples, the devices send battery status signals and/or processor status signals to the central controller. The central controller may be configured to allocate to one or more of the devices a processing operation to be carried out, in dependence on the battery status signals and/or the processor status signals. In this way, processing can be carried out within the network of devices in an efficient manner. For example, if a first hand controller is used more than a second hand controller, for example by a user moving the first hand controller more than the second hand controller, the first hand controller is likely to carry out a greater number of processing operations than the second hand controller. This may mean that the battery level of the first hand controller is depleted faster than the battery level of the second hand controller. The central controller may therefore allocate processing operations that might otherwise have been carried out at the first hand controller to the second hand controller. The central controller is suitably, in these cases, also configured to obtain relevant data from the first hand controller and to pass it to the second hand controller. In other examples, the central controller can carry out the processing operations that might otherwise have been carried out at the first hand controller. Such an arrangement helps prolong the battery life of one or more devices in the network.

The central controller is suitably configured to allocate a processing operation from a first device to a second device (including where the second device is the central controller) on determining from the battery status signals that a battery level of the first device is more than a threshold value lower than an average battery level of a group of devices comprising at least the second device.

The central controller is suitably configured to allocate a processing operation from a first device to a second device (including where the second device is the central controller) on determining from the processor status signals that a processing load of the first device is more than a threshold value higher than an average processing load of a group of devices comprising at least the second device.

User data can be recorded by one or more device of the system and uploaded to the client device, e.g. to an application running at the client device. An upload to the client device may occur via the wireless connection. An upload to the client device may occur during periods of less activity of the various wireless connections using a “lazy loading” protocol. An upload to the client device may occur at any time. The upload need not depend on the activity of the device. Thus, uploads to the client device can occur continuously. The uploaded data can be used to track the user's progression and fitness level, enabling the game to tailor the difficulty as players progress.

The devices suitably communicate with the client machine and each other via a central controller such as a USB dongle. Suitably, the devices and the central controller communicate with each other over a wireless connection. The wireless connection can not only be used to pass the recognised gestures (i.e. user movements that have been classified as one or more gestures) to the client machine (e.g. a PC), but can also pass data or heuristics from one device to another. The central controller can also be used for some parts of the classification pipeline.

It is not necessary for peripheral devices, such as the two hand controllers, to communicate with each other via the central controller. In some implementations, the devices can communicate with any other device. In other implementations, communication between peripheral devices is mediated by the central controller.

It is convenient for the devices to be configured to communicate with each other, since communicating over a network between the devices can help ensure that the communication network is agnostic to any other active communication connections used by the client device. For example, where the system devices, such as the peripheral devices and the central controller, communicate using the Bluetooth protocol, the use of the dedicated Bluetooth network between these devices means that the communication is not dependent on a Bluetooth connection with the client device, which could be affected by other Bluetooth connections of the client device, such as a headphones connection and the like.

In some implementations, the chest unit can be the central controller.

The controllers are used in conjunction with a wearable device comprising a belt worn around the upper waist. Resistance bands can be connected between the belt and each wrist to increase the force required to perform the movements and thereby increase the exercise efficacy. Resistance bands of different resistance can be used.

User actions (i.e. movements of the peripheral devices) may be classified into one or more gestures from data captured by one or more of the peripheral devices using a multi-stage classification model. The classification model may be based on Tensorflow Lite (TFLite) for Microcontrollers, which is a variant of TFLite for deploying ML models to embedded devices. The classified actions (recognised gestures) are suitably output to a user's device, such as the client device and used to control a computing system. For example, the gestures can be used as inputs to control an immersive role-playing game centred on two key types of activity: combat, with actions drawn from boxing or other combat sports (for example punching, blocking and dodging); and traversal, based on ambulatory/locomotive activities (for example running, ducking and jumping). These ML models can be updated to allow new actions to be recognised and/or personalisation to the user, providing increased performance.

The use of ML models proposed herein enables relatively smaller models which require less computational power to run inference than has conventionally been the case. The present techniques therefore permit real time analysis of sensor data on embedded devices, such as the hand controllers, chest unit and central controller. By keeping classification tasks on the wearable devices (i.e. the peripheral devices), it is sufficient to maintain a high-speed, or high-throughput, network connection only between the devices of the system, rather than needing to maintain a high-speed, or high throughput, network also with a client device. This is because only the gestures output by the system need to be passed to the client device, rather than needing to stream full data captured by all the sensors in real time. This arrangement helps make the system more robust to changes in a given user's environment and/or client device characteristics, such as processing power. The present techniques also help reduce the requirement for network throughput, helping to increase the speed of the network. The present techniques avoid the need to run classifiers (e.g. ML models) on client device hardware which may have limited or unexpected performance, instead only sending the classified actions (gestures) to the client device. This arrangement can therefore increase the accuracy of the system, and/or the behavioural reliability of the system.

The time taken to output a classification result (a gesture) is relevant, with computer system applications such as gaming systems often requiring the latency between the user performing an action and that action being recreated on screen to be imperceptible to the user (which in practice means a latency of less than about 150 ms, or suitably a latency of less than about 100 ms) so that they can e.g. react to incoming attacks from an in-game opponent. An increase in performance can be achieved by distributing classification tasks (i.e. processing operations) across the devices of the system. Such an arrangement enables more advanced classifier architectures by, for example, classifying hand-only actions on the hand controllers, and full body actions using only the chest unit, or only the central controller, or the complete network of devices. This enables power consumption to be reduced by avoiding streaming all data over longer distances to a remote client, and/or incurring excessive read/write operations to storage such as flash storage. To achieve the same functionality with the classification performed on the client device, high-speed connections from each device of the system would be needed, which would be likely to limit data throughput and increase power draw. This issue is compounded by the various Bluetooth versions that may be used on different client devices due to differences in latency, maximum data throughput, range, and stability.

The creation of a distributed network of devices is likely to require one or more of (i) precise synchronisation of the time series data recorded by each device, (ii) multithreading to permit continuous monitoring of sensor data while running inference tasks, and (iii) the ability to switch between different machine learning models in response to external or internal triggers, e.g. in response to changes in the computing system (such as a game) or the user's behaviour.

It is possible to further increase performance by feature engineering, in which more descriptive features are created from the raw data by scaling, filtering, or the combination of multiple sensor values to compute e.g. velocity or the absolute orientation of the module in free space.

Sensor fusion of the IMU data can be used on each device to compute additional features of the user's movement, including for example the absolute orientation (referenced against the direction of gravity), the velocity of each sensor, and/or the position of each sensor in free space. These values can be sent wirelessly to the chest unit for use in various processing techniques for interpreting user actions.

Feedback can be provided to a user of the peripheral devices. The feedback can include haptic feedback. A haptic signal may be generated by one or more of the plurality of devices, for example one or more peripheral devices. The haptic signal may be generated by a haptic actuator. Suitably the hand controllers include a haptic actuator 522. Suitably the chest unit includes a haptic actuator 622. The haptic actuator(s) 522, 622 can include a motor for driving a haptic response. The haptic actuator(s) 522, 622 can include a linear resonant actuator. Haptic feedback can be related to gameplay where a game is being run on the computing system, and being controlled by the devices. The feedback can correspond with the gameplay, for example by simulating effects of different materials or textures in the game, with the effects suitably being triggered using the wireless connections. Such feedback acts to increase a user's immersion in the game world.

The haptic actuator is suitably driven by a haptic driver integrated circuit (IC). The haptic vibrations are suitably between 10 Hz and 1 kHz. The haptic driver IC is controllable to control the intensity and/or frequency of vibrations caused by driving the haptic actuator. Suitably, the haptic driver IC is configured to avoid driving the haptic actuator to generate some types or forms of haptic vibration, since such haptic vibration may cause inaccuracies in the gesture recognition process, such as by triggering false gesture recognition.

An illustrated implementation of the gesture recognition system will now be described in more detail with reference to the figures.

The system can include a harness or strap which is arranged to be worn around the upper waist of a user. The system further includes straps 802, 804 worn on each wrist (see FIG. 8), with two resistance bands 902, 904 (see FIG. 9) connecting each wrist strap to the harness. The resistance bands 902, 904 are arranged to add resistance during extensions of the arm. The resistance to movement can be adjusted by changing the attachment point on the waist harness to increase or decrease the effective length of the band. The resistance may also be increased or decreased by changing the resistance band for a more stiff band or a less stiff band.

Each wrist strap suitably includes a thumb loop 806 for retaining the wrist strap in location about a user's wrist, a D-ring 808 for providing an attachment point to a portion of a resistance band, fastening fabric 810 (e.g. a portion of a hook and loop fastener) for securing the wrist strap about a user's wrist, a breathable fabric 812, such as a lightweight fabric and/or a perforated fabric, to avoid overheating the user's wrist, and a left/right indicator 814 to indicate to a user whether it is a left-hand or right-hand wrist strap.

Each resistance band suitably includes a G-hook 906 for hooking into one of several spaced loops on the harness, an adjustable portion 908 such as an adjustable strap or adjustable webbing for adjusting the length of the resistance band, a protective sheath 910 for covering a resilient portion of the resistance band, for example an elastomeric portion or a rubberised portion, and a fastener 912 for releasably fastening the resistance band to a wrist strap. The fastener can include any suitable releasable fastening, such as a carabiner snap hook, as illustrated in FIG. 9.

In an example implementation, one or both of the resistance bands includes a strain sensor such as a strain gauge. The strain gauge is configured to sense the strain of the resistance band. The sensor data generated by the strain sensor can be used to determine a resistance of the resistance band. Such information can be fed into a calorie determination calculation to more accurately calculate calories burnt when using the devices. Such information could also be used in the computer system (e.g. a game) to determine a characteristic of an action, and use that characteristic to modify control of the computer system. For example, such information can be used to determine the power with which an action is performed, which can be used, for example, to adjust the damage of an attack in a game setting. The strain gauge may be provided at one end of the resistance band, for example where the resistance band is attached to either the belt or the wrist strap.

A more detailed illustration of a pair of hand controllers 102, 104 is shown in FIG. 10. The hand controller 102 shown on the left of the figure includes inputs 1002 for receiving inputs from a user holding the hand controller. The inputs 1002 in this example include a home button, a thumbstick, a Y button, an X button and a trigger. The hand controller 104 shown on the right of the figure includes inputs 1004 for receiving inputs from a user holding the hand controller. The inputs 1004 in this example include a pause/options button, a thumbstick, an A button, a B button and a trigger. A heart rate monitor 1006 is provided on the right hand controller, in a location arranged to be adjacent a user's palm when the hand controller is being held. An LED indicator 1008 is provided on each hand controller. A lanyard connector 1010 can be provided on each hand controller, providing an attachment point for a lanyard, for more safely securing the hand controller to a user's hand during use.

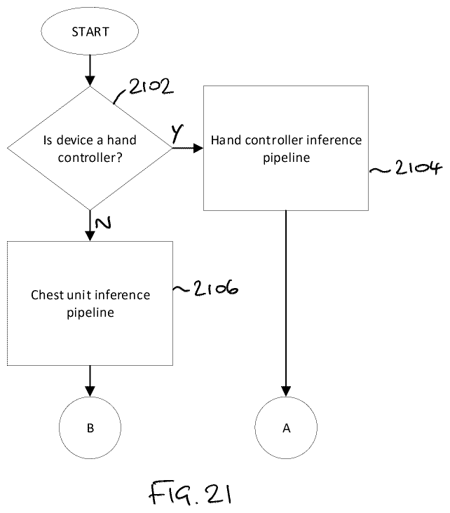

FIGS. 11A and 11B show perspective views of the lower and upper sides of the chest unit. The lower side of the chest unit includes a power button 1102 and a charging connector 1104. The upper side of the chest unit includes an LED indicator.

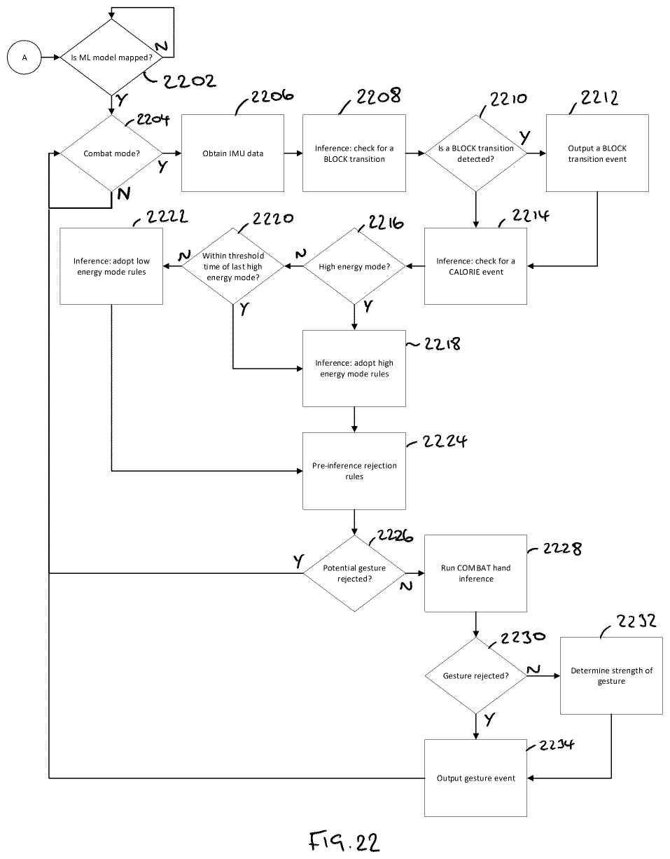

FIGS. 12A and 12B show perspective views of the lower and upper sides of the charging unit. The lower side of the charging unit includes a silicone grip 1202 for locating the charging unit more securely on a surface. The charging unit includes a charging port 1204. The upper side of the charging unit includes areas 1206, 1208, 1210 for charging a right controller, a chest unit and a left controller.

FIG. 13 shows two hand controllers 102, 104 and the chest unit 200 located in the charging dock 300.

FIG. 14 shows how a resistance band 902 can be releasably fastened to the harness or belt 1402. The belt 1402 includes a series of spaced loops 1404, 1406 in which the G-hook 906 of the resistance band 902 can be inserted.

FIG. 15 shows how the chest unit 200 can be mounted to the belt 1402. As illustrated, the belt includes a pocket 1502 in which the chest unit 200 fits snugly. The pocket of the belt holds the chest unit in position against the user's chest as the user wears the belt. The belt enables users to locate the chest unit over the sternum, aiding classification accuracy by ensuring more consistent conditions.

FIG. 16 illustrates how the belt 1402 is worn by a user. The resistance bands 902, 904 attach to an outside of the rear of the belt, so as to provide resistance to movement when attached to the wrist straps.

FIG. 17 shows the position of the chest unit 200 (illustrated in dotted lines) when held within the pocket 1502 of the belt 1402, as the user wears the belt.

FIG. 18 shows how a resistance band 904 can be releasably secured to a wrist strap 804. The fastener 912 at one end of the resistance band can secure fasten to the D-ring 808 of the wrist strap.

FIG. 19 illustrates a user holding two hand controllers, each fitted with a respective lanyard 1902, 1904 for looping around the user's wrists to ensure that the hand controllers are not dropped by the user.

FIG. 20 shows a user using the system, in which the user's right arm is extended in a punch gesture. A resistance band 904 resists user motion in gestures such as punch gestures in a direction of the punch.

In conjunction with details about the user like height, age, biological sex and weight, tracking of the rate and type of action and the user's heart rate enable the system comprising the wearable devices to provide an estimate of the calories a user has burned during a use session. This, combined with other metrics (for example heart rate, strike power, rate of strikes, number and distribution of different strikes, session time), is presented to the user before, during and after a session to help them understand their ability and fitness progression. This information is also used to update the difficulty level of the game, tailoring the experience to each user and increasing the difficulty as they get stronger and fitter.

Each action that the user can perform corresponds to the same action in-game, with a large set of possible strikes and other actions that are displayed in real time as the player performs them during combat, and similarly for other motions during a traversal mode. Combined with the haptic feedback and resistance, this enables the creation of dynamic, variable workouts by setting the type of enemy and/or difficulty level according to the user's skill level and desired workout type.

Together, the system allows the user to run, jump and fight in a natural, immersive way in a game that guides them through a workout that is tailored to their skill level, and provides them with resistance to enable strength training and a more efficient workout.

In coming up with the present techniques, the present inventors realised that basic heuristic calculations do not generalise well enough to be able to distinguish multiple similar actions. On the other hand, machine learning models alone tend to lead to a lot of false positives in gesture classification, and misclassification of other gestures. The present inventors have therefore realised that a combination of both approaches provides advantages over each approach on its own. In the rules engine described herein, a model input can be pre-processed, and a model output can be post-processed to provide better classification performance. The algorithm used to interpret the user's actions, which is a combination of gesture recognition techniques and embedded machine learning, provides results with greater accuracy and lower latency than conventional systems.

A context of a computer system that is controllable by the gestures can be used to determine what types of gesture can be considered acceptable, and can reject known inputs and/or outputs that are inconsistent with this determined type of gesture. For example, the context of a game being played by a user using the gesture recognition system can be used to determine the types of gesture that can be considered acceptable.

Different modes of the computer system, such as different modes of a game, can require different gestures, or different types of gesture. Thus, the rules engine to be used in processing sensor data can be selected in dependence on a mode of the computer system to be controlled. The rules engine to be used in processing sensor data can be selected in dependence on a mode of operation of the gesture recognition system.

Haptic motors in the controller can generate enough movement to trigger gesture inference—i.e. the haptic movement can be mistakenly interpreted as a gesture or as part of a gesture. The movement caused by the haptic motor and detected by the sensor(s) can be considered to be haptic interference. This haptic interference can be filtered out by subtracting a known signal (representing the haptic waveform) from generated sensor data. Instead of, or as well as, this approach, sensor data capture can be turned off when haptic feedback is being provided. Processing of sensor data captured when haptic feedback is being provided can be down-weighted. The system may be configured to ignore sensor data captures when haptic feedback is being provided.

The present techniques work in the following general way. Heuristic rules are applied to data that are based on automated searches of training data. Applying these heuristic rules can determine if the action is valid (i.e. if the action belonging to a target class of gesture) or not. Where the action is determined to be valid, a candidate action or gesture is passed to the trained ML model. Latent-space inference can be used to further enhance the precision and recall of the model. Open set recognition can be used to predict outputs belonging to known-invalid outputs and to reject them. A heuristic can be used to select which pre- and post-inference processing is used, depending on if the user is performing the action from a static pose (in what can be called a low energy mode of operation) or performing a rapid sequence of movements such as a volley of punches (in what can be called a high energy mode of operation).

Gesture classification or prediction is suitably based on known data and data received from the start of the movement, allowing prediction to be completed before the user has finished their movement in many cases. This means the “end” of the movement (e.g. the connection of the punch) can be synchronised with the control of the computing system (e.g. an in-game action). Using the present techniques can enable classification to take less than about 150 ms.

The present techniques will now be further explained with reference to FIGS. 21 to 33, illustrating schematic flow charts of various processing operations.

FIG. 21 shows an inference overview process. An initial check is made whether the device is a hand controller or not 2102. If the device is a hand controller, a hand controller inference pipeline 2104 is initialised. If the device is not a hand controller, a chest unit inference pipeline 2106 is initialised. The process of selecting between different inference pipelines means that general-purpose firmware can be used in a specific way, or tailored more easily to the desired application. For example, data-driven tailoring of a general-purpose firmware application enables easier deployment to (e.g.) additional control units for classifying a different set of actions and/or augmenting with different sensors.

Further detail of the hand controller inference pipeline is illustrated in FIG. 22. On initialising this pipeline, a check is made to see whether an ML model is mapped 2202. This check is a sanity check, to ensure that an ML model is available to the system, e.g. that it is loaded correctly, is accessible, and is not corrupted. ML models and their associated metadata, parameters, and both the inter- and intra-configuration of the heuristic rules may be loaded into a separate data partition, and may thereby be used to determine the flow of operations without manual modification to the main application. This means that ML models can be loaded that are invalid for that application version, so the check ensures not only the presence of an ML model but also the compatibility of the ML model. This check loops until the result of the check is positive, i.e. that there is an ML model mapped. The inference process cannot run where no ML model is mapped, so running this check in a loop until a positive outcome is achieved helps consume less battery power than proceeding through the pipeline. No useful output would be obtained where no ML model is mapped, so the use of the extra battery power would be wasted.

On determining that there is an ML model mapped, the system can initialise TFLite—an example of an ML library. This ML library has not heretofore been used in systems such as the present system. This initialisation need only be run once, and ensures that there is sufficient memory allocated for the ML model to run the inference operation.

The pipeline then checks if the system is in combat mode or not 2204. This is because, in this example, the hand controllers are only used to run gesture inference during combat mode. Thus, for any other mode, this loop is kept closed to reduce battery consumption. If the system is in combat mode, IMU data is obtained 2206, in an IMU pooling process.

In a combat mode, the pipeline is configured to analyse the data to determine the occurrence of punches, blocks and so on. A different mode is called a traversal mode. In the traversal mode, the pipeline is configured to analyse the data to determine the occurrence of running, jumping, ducking and other full-body movements.

The pipeline then proceeds to run an inference process to check if a BLOCK transition has occurred 2208. A BLOCK transition is a transition from an UNBLOCK state to a BLOCK state, or from a BLOCK state to an UNBLOCK state. A BLOCK state is where a user is holding a hand (or both hands) up in a blocking motion. If a BLOCK transition is detected 2210, a BLOCK transition event is output to the computer system 2212. A BLOCK transition can be detected based on the angle of a controller and/or a starting position. The BLOCK transition can be detected based on a movement between a starting and ending position.

If a BLOCK transition is not detected, or once the BLOCK transition event has been output, the pipeline runs an inference process to check if a CALORIE event has occurred 2214, i.e. whether the motion is sufficient to determine that a user is burning calories. A CALORIE event can be determined where a movement above a minimum movement has occurred. This movement can be logged for later calorie calculations.

The pipeline next checks if the system is in a high energy mode, or a high energy state, 2216. If so, the pipeline proceeds to an inference process based on high energy rules 2218. If the system is not in a high energy mode the pipeline checks whether the system is within a threshold time of the last high energy mode event 2220. In at least some examples, the threshold time is less than approximately 300 ms, or less than approximately 200 ms or less than approximately 150 ms. The threshold time may be approximately 150 ms. If the time since the last high energy mode is within this threshold time, the pipeline proceeds to the inference process based on high energy rules 2218.

If the time since the last high energy mode exceeds the threshold time, the pipeline proceeds to an inference process based on low energy rules 2222.

The high and low energy modes offer alternative approaches to detecting the start of a gesture, and/or detecting the gesture. The use of two modes enables more accurate gesture recognition. If starting from a static position (low energy mode), a total movement can be analysed, and data passed to the ML model. If starting from a moving position (high energy mode), there is more overall movement so it can be harder to detect the start and end points, and significant features within, a given gesture within that overall movement.

Proceeding from either the inference process based on high energy rules or the inference process based on low energy rules, the pipeline runs pre-inference rejection rules 2224. Whilst FIG. 22 shows separate blocks for the pre-inference rejection rules 2224, and inference processes based on high energy rules 2218 and low energy rules 2222, it is not necessary in all examples for this division to be strictly adhered to. The pre-inference rejection rules can be employed as part of the high energy rules block 2218 and/or the low energy rules block 2222. In some examples, rejection rules can be employed at different, and/or multiple, parts of the processing pipeline. The pre-inference rejection rules enable a check to be made on the gesture. For example, a gesture may look like a punch, but on applying these pre-inference rejection rules, which may include a set of heuristic rules, it can be determined that the gesture was not a punch (or it was not a punch with a high enough confidence score). Rejecting gestures that do not meet certain criteria at this stage means that the ML model need not be run on input data that is unlikely to give an accurate result. Thus, the pipeline can avoid running the ML model for hand movements that are not gestures of a type that the system is configured to detect. For example, minor hand movements need not cause the ML model to be run. Thus, this process, whereby pre-inference rejection rules are run on potential gesture input data, can mean that the ML model is not run needlessly, thereby saving processing power and time, and allowing the system to remain in a state where it can respond instantaneously to a gesture event.

If the gesture is rejected 2226, the pipeline returns to check whether the system is in combat mode 2204.

If the gesture is not rejected, the pipeline proceeds to run a combat hand inference process 2228. In this process, the data is passed to an ML model to determine if a gesture is recognised, and a subsequent check is made to determine if the potential gesture is rejected 2230. If the gesture is rejected, the rejected gesture can be sent to the computer system, e.g. for logging purposes. If the gesture is not rejected, the pipeline proceeds to determine a gesture strength 2232. The recognised gesture, together with the gesture strength is then output to the computer system as a gesture event 2234, and the pipeline returns to check whether the system is in combat mode 2204.

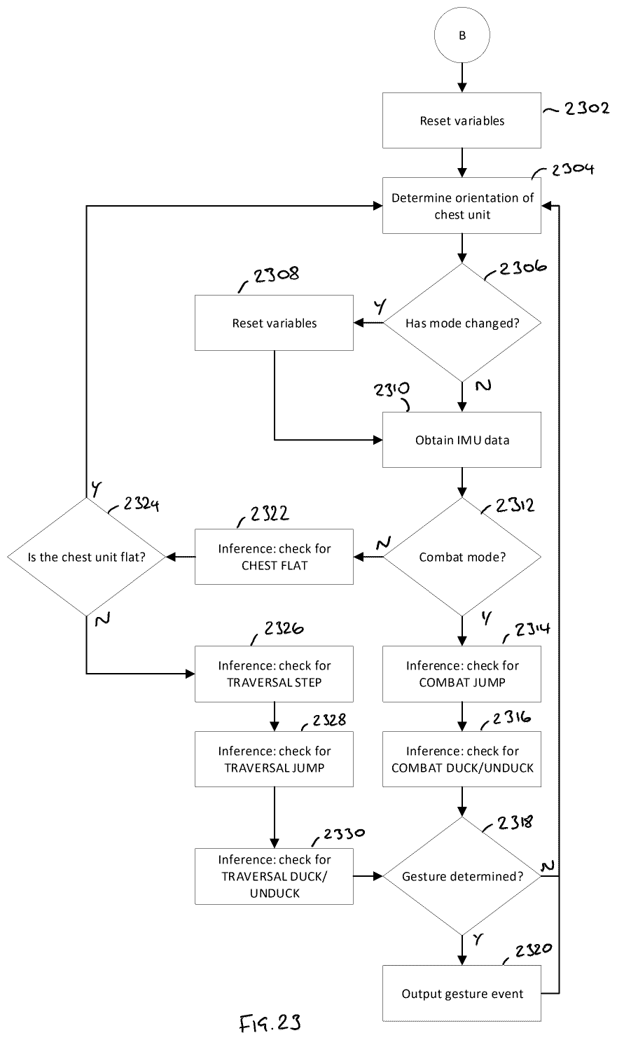

Further detail of the chest unit inference pipeline is illustrated in FIG. 23. As an optional initial stage, variables used in this inference pipeline can be reset 2302. For example, a gesture variable can be set to ‘none’ and a strength variable can be set to ‘zero’. The pipeline determines an orientation of the chest unit 2304. The chest unit will have a certain orientation when properly held in the belt pocket, where the flat surface is against a user's chest, e.g. a normal to this surface is generally horizontal. The chest unit will have a different orientation when laid on a flat surface, such as a table or the floor, e.g. a normal to this surface is generally vertical. Determining the orientation of the chest unit therefore allows a check as to whether the chest unit is properly oriented (in which case it is more likely to output relevant data) or whether the chest unit is not properly oriented (in which case the output data is not likely to be relevant). Where the orientation is generally correct, in that the chest unit is flat against a user's chest, it might still be facing the wrong way. A description will be provided elsewhere herein of how this can be taken into account.

If the chest unit is generally correctly oriented, the pipeline proceeds to check if the mode has changed since the previous iteration 2306. If the mode has changed, variables relevant to this pipeline can be reset 2308 before the pipeline proceeds to obtain IMU data 2310. If the mode has not changed, the pipeline proceeds to obtain IMU data 2310 without needing to reset variables.

If the system is in combat mode 2312, the pipeline proceeds to sequentially run inference processes to check for a COMBAT JUMP event 2314, and a COMBAT DUCK or UNDUCK event 2316 (a DUCK event is a user ducking, and an UNDUCK event is a user straightening up following a duck). A check is made to see whether a gesture is determined in these inference processes 2318. If not, the pipeline returns to determine the orientation of the chest unit 2304.

If a gesture is determined at 2318, the pipeline outputs a gesture event to the computer system 2320 (e.g. sending the gesture event to a game), and the pipeline returns to determine the orientation of the chest unit 2304.

If, at 2312, the pipeline determines that the system is not in combat mode, the pipeline proceeds to run an inference process to check if the chest unit is likely to be lying flat 2322. If the result of this check 2324 is that the chest unit is lying flat (and so not likely to generate any useful data since it is not being held correctly in place in the belt pocket), the pipeline returns to determine the orientation of the chest unit 2304. If the result of this check 2324 is that the chest unit is not lying flat (and so may be generating useful data), the pipeline proceeds to sequentially run inference processes to check for a TRAVERSAL STEP event 2326, a TRAVERSAL JUMP event 2328 and a TRAVERSAL DUCK/UNDUCK event 2330.

A check is made to see whether a gesture is determined in these inference processes 2318. If not, the pipeline returns to determine the orientation of the chest unit 2304.

If a gesture is determined at 2318, the pipeline outputs a gesture event to the computer system 2320 (e.g. sending the gesture event to a game), and the pipeline returns to determine the orientation of the chest unit 2304.

Where the pipeline sequentially runs inference processes, the last gesture inferred in a sequence will, in at least some examples, be output as a gesture event. That is, in a sequence for detecting a COMBAT JUMP event and a COMBAT DUCK/UNDUCK event, if only a COMBAT JUMP is detected, this gesture is output as the gesture event. If only the COMBAT DUCK/UNDUCK is detected, this gesture is output as the gesture event. If both are detected, then the latest detected gesture, i.e. the COMBAT DUCK/UNDUCK gesture, is output as the gesture event. A similar principle applies for the sequence for detecting TRAVERSAL STEP, TRAVERSAL JUMP and TRAVERSAL DUCK/UNDUCK gestures. Where a TRAVERSAL DUCK/UNDUCK gesture is detected, this gesture will be output as the gesture event, irrespective of whether or not a gesture was detected earlier in this sequence. A TRAVERSAL JUMP gesture will be output as the gesture event where detected and there is no subsequent detection in this sequence of a TRAVERSAL DUCK/UNDUCK gesture. A TRAVERSAL STEP gesture that is detected will only be output as the gesture event where there is no later detection in this sequence of a TRAVERSAL JUMP or a TRAVERSAL DUCK/UNDUCK gesture.

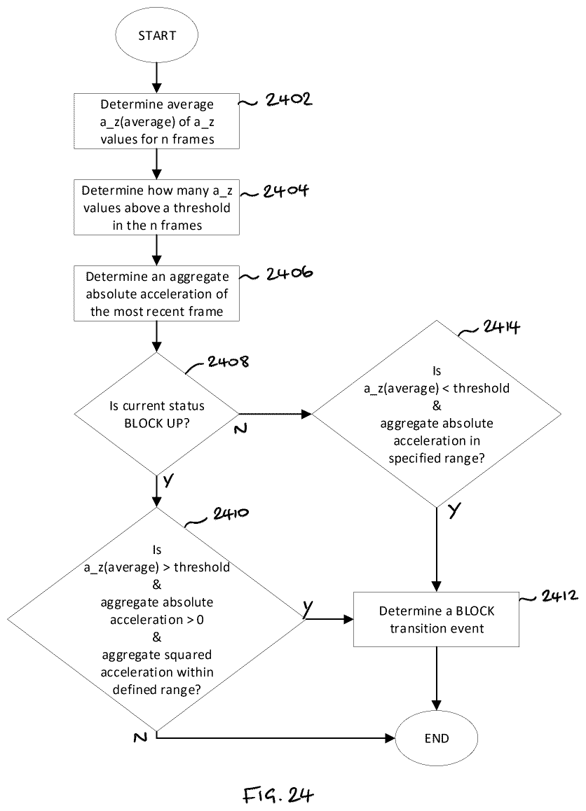

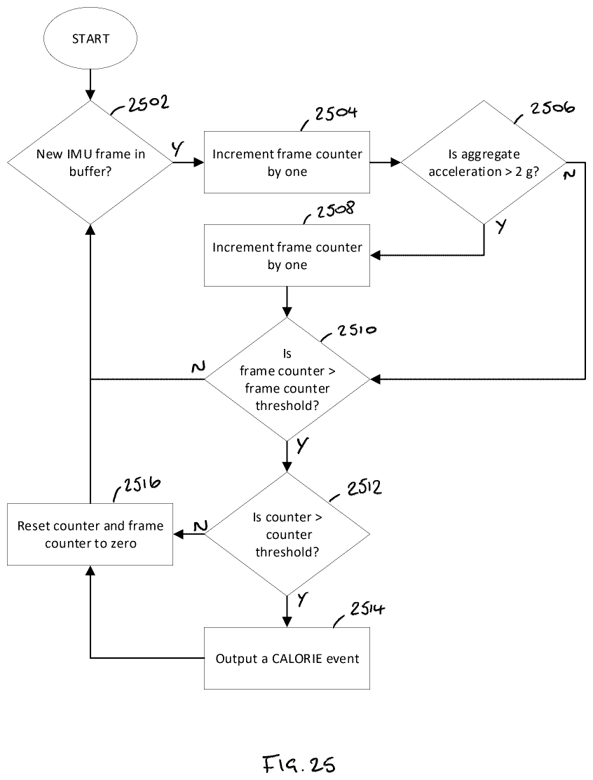

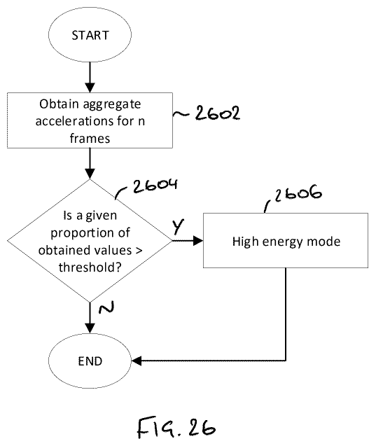

FIG. 24 shows details of the inference process for determining a BLOCK transition in one example. An average a_z(average) is determined for a_z values for a number, n, of previous IMU frames of data 2402. n can be in the range of 20 to 30 frames, for example 25 frames. a_z is an acceleration value along the z-axis. A determination is made of how many a_z values in the n frames exceed a threshold a_z value 2404. The threshold value can be in the range 0.5 g to 0.8 g, for example approximately 0.7 g. An aggregate absolute acceleration value for the most recent frame is determined 2406.

A check is made to see whether the current BLOCK status is BLOCK UP 2408. If so, a check is made to see (i) whether the a_z(average) value is greater than a threshold value (which may be zero) and (ii) that aggregate absolute acceleration is greater than zero and that aggregate squared acceleration is within a defined range 2410. A lower end of the defined range may be at least 100, or at least 120, or at least 140. An upper end of the defined range may be up to 800, or up to 750, or up to 650. (There may be an additional check on a_y that ensures that a user can only exit a BLOCK state by extending their arms at the elbow (i.e. moving their hands away from their body), and not by tilting their hands further back towards them.) If the check criteria (optionally including the additional check criteria) are not met, the process ends; if the check criteria (optionally including the additional check criteria) are met, the process proceeds to determine a BLOCK transition gesture 2412, e.g. that a BLOCK DOWN gesture has occurred.

If, at 2408, the current BLOCK status is not BLOCK UP, the pipeline proceeds to check if the a_z(average) value is less than a given threshold and whether the aggregate absolute acceleration value is within a specified range 2414. If not, the process ends. If so, the process proceeds to determine a BLOCK transition gesture 2412. The given threshold can be approximately −1 g, or approximately −0.8 g, or approximately −0.75 g. The lower bound of the specified range is ≥100, or ≥120, or ≥140. The upper bound of the specified range is ≤800, or ≤700, or ≤650.

FIG. 25 shows details of a CALORIE inference process. If a new IMU frame is held in a buffer 2502, a frame counter is incremented by one, and a check is made whether an aggregated acceleration on either hand is greater than 2 g 2506. If so, a counter (tracking the number of times that the aggregated acceleration exceeds 2 g—note that this value is not critical; acceleration values above or below this value are acceptable, e.g. in the range 1.8 g to 2.2 g) is incremented by one 2508. The process then checks if the frame counter exceeds a frame counter threshold 2510, to check if there have been enough frames to determine that a calorie event has occurred. If the aggregated acceleration does not exceed 2 g, the process proceeds to the same check at 2510 without incrementing the counter.

If, at 2510, there have not yet been enough frames, the process returns to check for a new IMU frame in the buffer 2502. If there have been enough frames, the counter is compared to a threshold to check if the number of times that the aggregated acceleration has exceeded 2 g has met the threshold number of times 2512. This threshold may be at least 40%, or at least 50%, or at least 55%, or at least 60%, or at least 70% of a required number of frames. The required number of frames may represent a period of approximately 0.3 to 0.7 second, for example 0.5 seconds, so the threshold may represent the situation of the aggregated acceleration having exceeded 2 g for more than 50%, or for more than 55%, or for more than 60% of a 0.5 second period. Other thresholds can be chosen; these values are not critical.

If this check is positive, the pipeline outputs a CALORIE event to the computing system 2514. If this check is negative the counter and the frame counter are reset to zero 2516, and the process returns to check for a new IMU frame in the buffer 2502.

FIG. 26 shows details of a process to check whether the system is in the high energy mode. Aggregated accelerations are obtained for n recent frames 2602. n can be in the range 25 to 30 frames. The aggregated accelerations can form an array. A check is made to see whether a given proportion of the obtained values are greater than a threshold value 2604. The given proportion can be greater than about 75%, or greater than about 80%, or greater than about 90%. In one example, the proportion is approximately 85%. The threshold value can be greater than about 2 g, or greater than about 2.5 g, or greater than about 3 g. If this check is positive, the system transitions to or remains in a high energy mode 2606. If the check is not positive, the process ends.

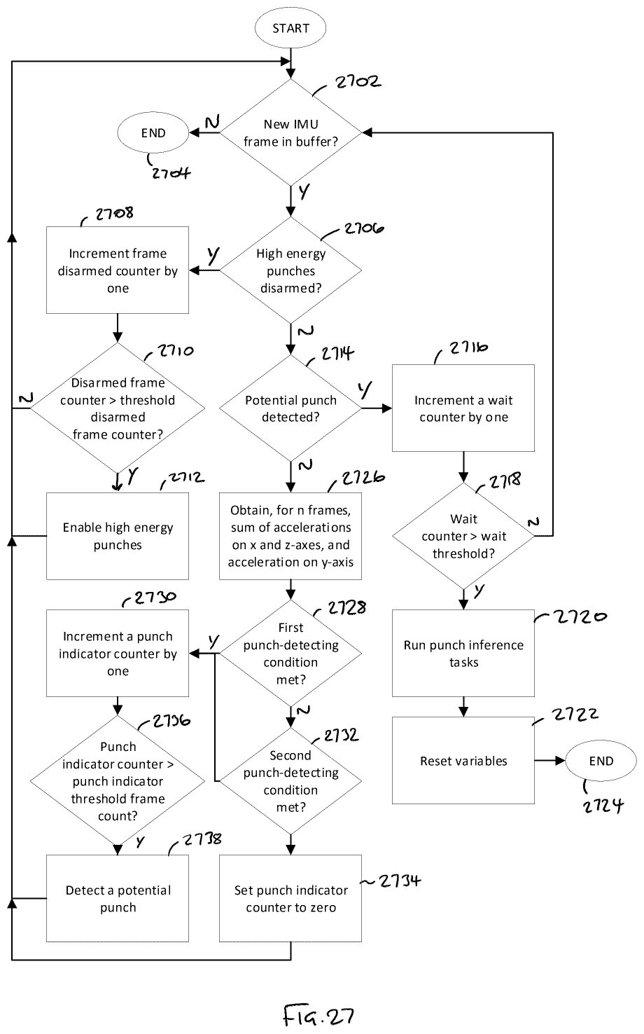

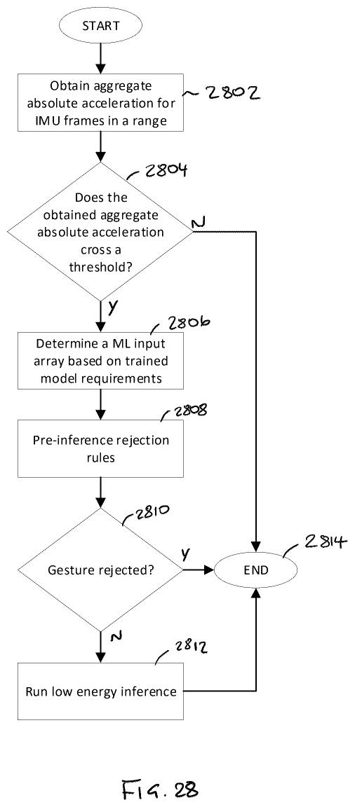

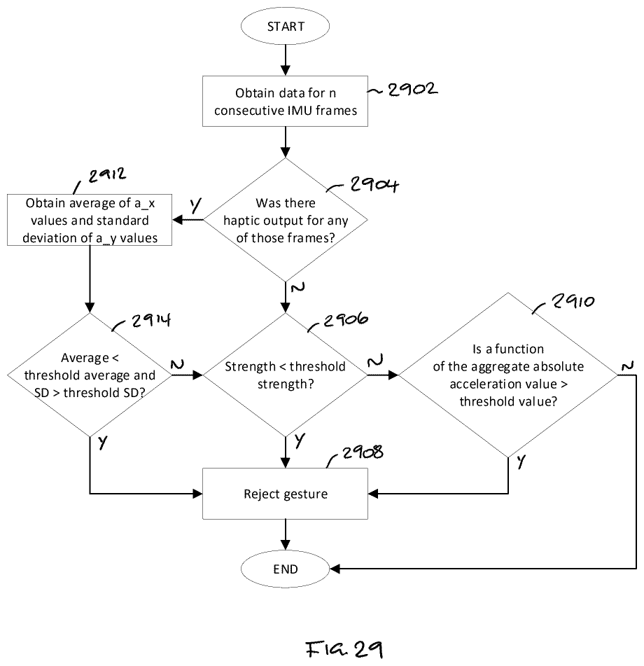

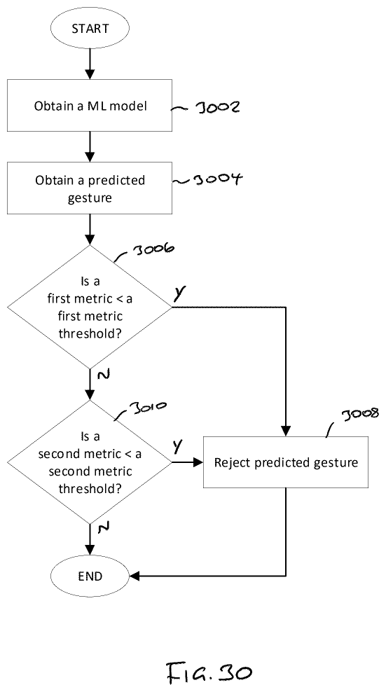

FIG. 27 shows details of an inference process in a high energy mode. A check is made whether a new IMU frame is in a buffer 2702. If not, the process ends 2704. If a new frame is in the buffer, a check is made whether high energy punches are active or have been disarmed (are inactive) 2706. If disarmed, a frame disarmed counter is incremented by one 2708 (counting a number of frames for which punches are disarmed, e.g. a number of frames for which no punch has been detected) and a check is made whether the frame disarmed counter is greater than a threshold frame disarmed counter 2710 (i.e. whether sufficient time has passed since the last detected punch, so that a new punch might be expected). If the frame disarmed counter is greater than the threshold frame disarmed counter, high energy punches are enabled 2712.

If, at 2706, high energy punches have not been disarmed, a check is made for detection of a potential punch 2714. If a potential punch is detected, a wait counter is incremented by one 2716 and this is checked against a wait threshold 2718. If the wait counter is not greater than the wait threshold (i.e. a potential punch has been detected for less than a threshold time), the process reverts to checking for a new IMU frame in the buffer 2702. If the wait counter exceeds the wait threshold, i.e. the time for which a potential punch has been detected is long enough that sufficient data have been captured to run an inference process to determine what type of punch occurred, the process proceeds to run punch inference tasks 2720. Following this, variables are reset 2722 and the process ends 2724.

If, at 2714, a potential punch is not detected, the process obtains data for checking against other criteria 2726. In the illustrated example, the system obtains, for n frames, a sum of accelerations on the x- and z-axes and the acceleration on the y-axis. Based on this data, the process checks whether a first punch-detecting condition is met 2728. If so, a punch indicator counter is incremented by one 2730. If not, the process checks whether a second punch-detecting condition is met 2732. If so, a punch indicator counter is incremented by one 2730. If not, the punch indicator counter is set to zero 2734 and the system returns to check for a new frame in the IMU buffer 2702.

After incrementing the punch indicator counter by one 2730, the punch indicator counter is compared to a punch indicator threshold frame count 2736. If the punch indicator counter exceeds the punch indicator threshold frame count, a potential punch is detected 2738. The threshold frame count is suitably approximately 10 frames, e.g. in the range 7 to 10 frames, or 8 to 10 frames, e.g. 9 frames. Multiple frames are considered, rather than relying on data from a single frame (or relying on data from fewer frames than the punch indicator threshold frame count) to increase the confidence that a punch has occurred by increasing the data on which the decision is based.

It is useful to have two conditions that can separately cause the system to determine that a potential punch has occurred so that punches with different characteristics can be determined. In other examples, a greater number of conditions may be provided. In other examples, where a given characteristic is common to all gestures to be detected, a single condition may be sufficient.

In the present example, the first punch-detecting condition is suitably the determination that a change in a_y acceleration values is above a threshold change. For example, the change can be determined over at least a subset of the n frames. The threshold change can be at least about 10%, at least about 15%, or at least about 20%.

In the present example, the second punch-detecting condition is suitably the determination that a change in the summed a_x and a_z values is above a threshold change. For example, the change can be determined over at least a subset of the n frames. The threshold change can be at least about 10%, at least about 15%, or at least about 20%. In one example, the change can be determined by analysis of the standard deviation (SD) of the values. The change can be determined by comparing the SD of the values with a threshold SD.

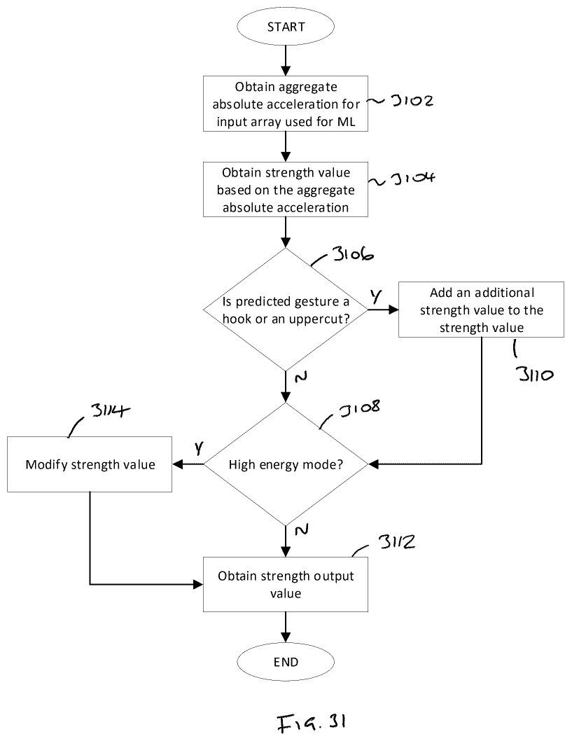

FIG. 28 shows details of an inference process in a low energy mode. The process starts by obtaining aggregate absolute acceleration values for IMU frames in a range of frames 2802. The range of frames selected suitably depends on the trained ML model. A check is then made whether this aggregate absolute acceleration value crosses a threshold 2804, i.e. is a preceding value less than a threshold and a current value more than the threshold? If so, an ML input array is determined based on trained ML model requirements 2806. The array, for example the shape and/or size of the array, suitably depends on the trained ML model. The array used can differ between controllers, but it need not.

Pre-inference rejection rules are then run 2808 and a check is made whether the gesture has been rejected 2810. If the gesture is rejected by the pre-inference rejection rules, the process ends 2814, otherwise the process continues to run low energy inference 2812.

It is noted that the inference process to adopt low energy rules described with reference to FIG. 28 includes applying pre-inference rejection rules. The subdivision of specific processing operations within the modules or tasks shown in the figures is not critical. FIG. 22 illustrates pre-inference rejection rules 2224 occurring separately from an inference process to adopt low energy mode rules 2222.

As illustrated in FIG. 28, it is advantageous to run the pre-inference rejection rules before running the full inference process involving the ML model, so that processing time is not wasted on potential gestures that would be rejected and may further cause subsequent valid gesture events to be missed, or classified with an increased delay, due to a processor being occupied with the current inference task.

An example of a set of pre-inference rejection rules will now be described with reference to FIG. 29. Data for a set of IMU frames is obtained 2902. Suitably the frames are consecutive frames. The number of frames in the set is approximately 30 frames. The number of frames in the set is suitably in the range 10 to 50 frames, for example 10 to 40 frames, or 10 to 30 frames. The number of frames in the set may be between 20 and 30 frames. A check is made for any haptic output during that set of IMU frames 2904. If there was no haptic output present (i.e. the IMU data was not affected by possible haptic motion), a strength of a potential gesture is compared to a threshold strength 2906. If the strength of the potential gesture is less than the threshold strength, the gesture is rejected 2908. For example, the potential gesture may be too small to be categorised as a gesture, or recognised as a gesture.

If the strength is not less than the threshold strength, a further numeric check is made on the data 2910. In the illustrated example, a numerical check is made against an aggregate absolute acceleration value, for example by checking whether a given function of the aggregate absolute acceleration is greater than a threshold value or not. If so, the gesture is rejected 2908, otherwise the process ends (and so may therefore pass the relevant data to an ML model for a gesture recognition process).

If, at 2904, haptic output occurred, the process proceeds to obtain an average of a_x values and SD of a_y values 2912. Where the average is less than a threshold average and the SD is above a threshold SD, the gesture is rejected 2908. Otherwise, the process passes to the strength comparison 2906, and proceeds as already described.

A combat hand inference process will now be described in more detail with reference to FIG. 30. An ML model is obtained 3002 and a predicted gesture is obtained 3004. At 3006, a check is made whether a first metric is less than a first metric threshold. If so, the predicted gesture is rejected 3008. Otherwise, at 3010 a check is made whether a second metric is less than a second metric threshold. If so, the predicted gesture is rejected 3008. The first metric may include a distance metric such as Cosine Distance or a cosine similarity function. A Cosine Distance may include determining a cosine distance between the same two elements, based on a current input to each averaged gesture. The second metric may include a distance metric such as an LR (Logistic Regression) Distance. A Logistic Regression model may be trained to compute a value that can be understood as the distance from the current input (unknown gesture) to the average of each kind of gesture present in a gesture dataset.

Whilst this example process includes two checks, one involving a first metric and another involving a second metric, in other examples it may be sufficient for the process to include one check. In other examples the process may include more than two checks. The one or more checks enables a rejection of the gesture where certain conditions are not met. A condition may represent a timing condition—for example, how long has the gesture taken? If the gesture is too short to reliably be a given gesture, then it can be rejected. A condition may represent a strength condition—for example, how strong was the gesture? If the gesture is not strong enough to be a given gesture, then it can be rejected. A condition may represent a movement condition—for example, what was the extent of movement of the gesture? If the extent of movement of the gesture is not enough to be a given gesture, then it can be rejected. The use of such conditions can increase the confidence that the prediction is a real gesture, for example by rejecting other motions that are not to be recognised as gestures, such as a small flick of the wrist.

FIG. 31 shows a process for determining a gesture strength. At 3102, the process obtains an aggregate absolute acceleration for an input array used for ML. At 3104, the process obtains a strength value based on the aggregate absolute acceleration. a check is made at 3106 whether the predicted gesture is a hook or an uppercut. If neither, the process proceeds to check whether the system is in the high energy mode 3108. If the predicted gesture is a hook or an uppercut, the process adds an additional strength value to the strength value. This additional strength value can be used to more accurately characterise the gesture. The process then proceeds to 3108. If the system is not in the high energy mode, the process obtains a strength output value 3112. If the system is in the high energy mode, the strength value is modified 3114 before the strength output value is obtained 3112. The modification suitably accounts for differences between the high energy mode and the low energy mode. When the system is in the high energy mode, a user is typically more active. This can lead to higher strength values. The modification suitably normalises the strength value so that it is in the same range as a gesture detected in the low energy mode. Obtaining the strength output value at 3112 can also include a normalisation process, to help ensure that the output strength value is within a desired range of strength values.

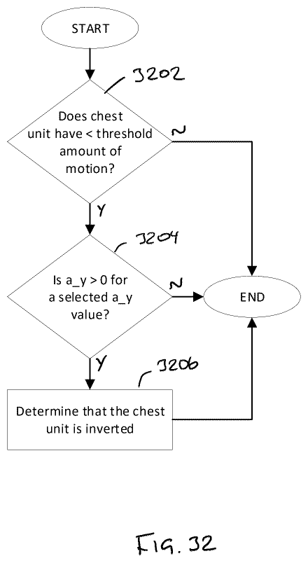

FIG. 32 shows a process for determining an orientation of the chest unit. At 3202 it is determined whether the chest unit has less than a threshold amount of motion, for example whether the chest unit is still (i.e. whether the chest unit is not moving). The threshold amount of motion can, for example, include an acceleration of at least 0.9 g, or an acceleration of up to 1.4 g, or an acceleration in the range 0.9 g to 1.4 g. If the chest unit has less than the threshold amount of motion, a check is made whether the acceleration value in the y-direction, a_y, is greater than zero for a selected a_y value 3204 (e.g. a selected location in an array of a_y values). The selected a_y value can, for example, be the first a_y value in a buffer. If this check is positive, a determination can be made that the chest unit is inverted 3206.

On determining that the chest unit is inverted, which may occur when the chest unit is inserted the wrong way round into the belt pocket. The system is still able to usefully continue to recognise gestures and to output them to a computer system. Analysis of the data captured by the chest unit, for example analysis of the acceleration values in one or more directions, can provide information relating to the orientation of the chest unit, such as which way is down (e.g. in a frame of reference where ‘down’ is relative to Earth's gravity, e.g. a gravitational direction). The system is then suitably configured to map the data captured by the chest unit into a new frame of reference such that the re-mapped data values correspond to data values that would have been captured had the chest unit been correctly oriented. For example, if the chest unit is inverted such that an ‘up’ direction of the chest unit (when correctly oriented) aligns with a ‘down’ direction (i.e. the gravitational direction), sensor data can remap the ‘up’ direction to the ‘down’ direction and vice versa. For example, a reading from an inverted chest unit of +1 can be mapped to a reading of a non-inverted chest unit of −1. Subsequent processing of the data can be carried out using the remapped data.

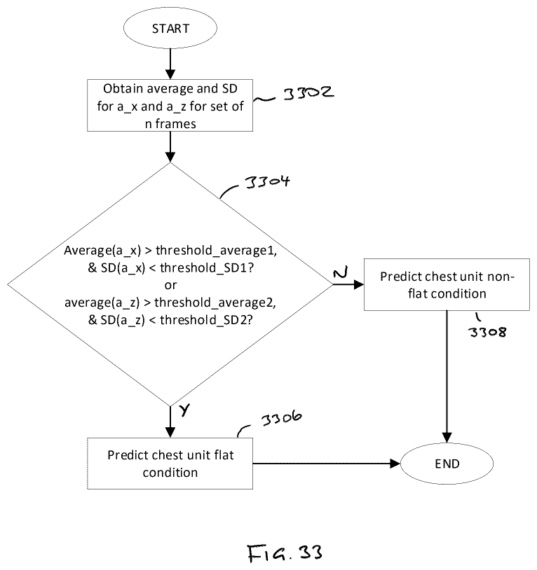

FIG. 33 shows an inference process to check for a situation in which the chest unit is flat. The process obtains an average and SD for a_x and a_z values (accelerations in the x- and z-directions), over a set of n frames 3302. n is suitably in the range of 5 to 10 frames, or 5 to 15 frames. The process then determines whether either:
i) an average of the a_x values is greater than a first threshold average and a standard deviation of the a_x values is less than a first threshold SD; or
i) an average of the a_z values is greater than a second threshold average and a standard deviation of the a_z values is less than a second threshold SD.

The first threshold average and the second threshold average can be the same, but they need not be the same. The first threshold SD and the second threshold SD can be the same, but they need not be the same. The first threshold average and/or the second threshold average is suitably in the range 0.5 g to 1 g, for example 0.75 g. The first threshold SD and/or the second threshold SD is suitably in the range 80 to 120, for example 100.

If either condition is true, the system predicts a CHEST FLAT situation 3306, i.e. that the chest unit is flat, for example lying on a table. If neither condition is true, the system predicts a non-CHEST FLAT situation 3308.

In some examples, analysis of the sensor data can be used to determine when a resistance band is being used. Where no resistance band is being used, as a user extends their arm, there is no change to the resistance of movement, so a smooth acceleration change is expected. When a resistance band is being used, the initial movement will be the same as where no resistance band is being used. Once the resistance band becomes taught, further movement will cause it to stretch, adding resistance to the further movement. The sensor data will therefore show a change in the acceleration values at the point in time when the resistance band becomes taught, compared to the change in acceleration values where no resistance band is being used. Similarly, a change in the acceleration values will occur as the resistance band becomes slack. Such changes in the acceleration values enable a determination to be made of whether or not a resistance band is being used. This determination can be used to increase the accuracy of a subsequent calculation of the calories burnt using the devices.

Where more than one resistance band is available for use, analysis of the acceleration changes during a movement can be used to determine, in at least a qualitative way, which resistance band is being used. That is, where there is a relatively stiffer resistance band and a relatively less stiff resistance band, the relative changes in the acceleration values can be used to determine not only whether or not a resistance band is being used, but also whether the resistance band in use is the relatively more stiff or the relatively less still resistance band.

The gesture recognition system of FIGS. 5 to 7 are shown as comprising a number of functional blocks. This is schematic only and is not intended to define a strict division between different logic elements of such entities. Each functional block may be provided in any suitable manner. It is to be understood that intermediate values described herein as being formed by a gesture recognition system need not be physically generated by the gesture recognition system at any point and may merely represent logical values which conveniently describe the processing performed by the gesture recognition system between its input and output.

The gesture recognition system described herein may be embodied in hardware on an integrated circuit. The gesture recognition system described herein may be configured to perform any of the methods described herein. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be or include any kind of general purpose or dedicated processor, such as a CPU, GPU, NNA, System-on-chip, state machine, media processor, an application-specific integrated circuit (ASIC), a programmable logic array, a field-programmable gate array (FPGA), or the like. A computer or computer system may include one or more processors.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the current subject matter may consist of any such individual feature or combination of features. In view of the foregoing description it will be evident to a person skilled in the art that various modifications may be made within the scope of the invention.

1. A gesture recognition system for recognising gestures from a set of input data and outputting gesture events on recognising gestures, the output gesture events being for controlling a computing system, the gesture recognition system comprising:
a plurality of devices configured to be in communication with each other; the plurality of devices comprising:
one or more peripheral devices, each peripheral device comprising:
a set of one or more sensors for sensing one or more parameters of a set of parameters;
a communication module configured to communicate with one or more devices of the plurality of devices; and
a processor configured to:
process sensor data generated by the set of sensors using a rules engine thereby to recognise a gesture from the sensor data; and
output a gesture event in dependence on recognising the gesture from the sensor data; and
a central device, the central device comprising:
a central communication module configured to communicate with the one or more peripheral devices; and
a central processor configured, in dependence on processing one or both of (i) at least a subset of the sensor data and (ii) data relating to the gesture, to output a further gesture event;
wherein at least one of the gesture event and the further gesture event is for controlling the computing system.

2. The gesture recognition system of claim 1, in which the rules engine is selectable in dependence on a mode of the gesture recognition system and/or a mode of the computing system.

3. The gesture recognition system of claim 1, in which the rules engine comprises heuristic rules and a Machine Learning model.

4. The gesture recognition system of claim 3, configured to process the sensor data using the Machine Learning model in dependence on a result of processing the sensor data using the heuristic rules.

5. The gesture recognition system of claim 1, in which the set of parameters comprises at least one of:
an acceleration in one or more directions;
one or more position data;
one or more velocity data;
a magnetic field in one or more directions;
a pressure value; and
a heart rate value.

6. The gesture recognition system of claim 1, in which the set of one or more sensors comprises at least one of:
an accelerometer;
a magnetometer;
a barometer; and
a heart rate sensor.

7. The gesture recognition system of claim 1, in which the further gesture event comprises a refinement of the gesture event, and/or recognising a further gesture.

8. The gesture recognition system of claim 1, in which the communication module and the central communication module each comprise a respective radio configured to communicate wirelessly.

9. The gesture recognition system of claim 1, configured to filter the sensor data before processing the sensor data.

10. The gesture recognition system of claim 9, configured to generate a haptic signal, the gesture recognition system being configured to filter the sensor data to reduce the effect of the haptic signal on the sensor data.

11. The gesture recognition system of claim 1, configured, in dependence on an analysis of the sensor data, to remap the sensor data before processing the sensor data.

12. The gesture recognition system of claim 11, configured to remap the sensor data by inverting an axis along which sensor data is captured.

13. A method of recognising gestures in a gesture recognition system from a set of input data and outputting gesture events on recognising gestures, the output gesture events being for controlling a computing system, the method comprising:
sensing, at one or more sensors of a set of sensors of one or more peripheral device, one or more parameters of a set of parameters;
processing, at a first processor, sensor data generated by the set of one or more sensors using a rules engine thereby to recognise a gesture from the sensor data;
generating a gesture event in dependence on recognising the gesture from the sensor data;
processing at a second processor, one or both of (i) at least a subset of the sensor data and (ii) data relating to the gesture, and generating a further gesture event in dependence on that processing; and
outputting one or both of the gesture event and the further gesture event for controlling the computing system.

14. The method of claim 13, comprising selecting the rules engine in dependence on a mode of the gesture recognition system and/or a mode of the computing system.

15. The method of claim 13, in which the rules engine comprises heuristic rules and a Machine Learning model.

16. The method of claim 15, comprising processing the sensor data using the Machine Learning model in dependence on a result of processing the sensor data using the heuristic rules.

17. The method of claim 13, in which generating the further gesture event comprises refining the gesture event, and/or recognising a further gesture.

18. The method of claim 13, comprising filtering the sensor data before processing the sensor data.

19. The method of claim 13, comprising, in dependence on an analysis of the sensor data, remapping the sensor data before processing the sensor data.

20. A non-transitory computer readable storage medium having stored thereon computer readable instructions that, when executed at a computer system, cause the computer system to perform a method comprising:
sensing, at one or more sensors of a set of sensors of one or more peripheral device, one or more parameters of a set of parameters;
processing, at a first processor, sensor data generated by the set of one or more sensors using a rules engine thereby to recognise a gesture from the sensor data;
generating a gesture event in dependence on recognising the gesture from the sensor data;
processing at a second processor, one or both of (i) at least a subset of the sensor data and (ii) data relating to the gesture, and generating a further gesture event in dependence on that processing; and
outputting one or both of the gesture event and the further gesture event for controlling the computing system.
